(19) United States
(12) Patent Application Publication
(10) Pub. No.: US 2011/0137659 A1
(43) Pub. Date: Jun. 9, 2011

(54) Frequency Band Extension Apparatus and Method, Encoding Apparatus and Method, Decoding Apparatus and Method, and Program

(76) Inventors: Hiroyuki Honma, Chiba (JP); Toru Chinen, Kanagawa (JP); Yuki Yamamoto, Tokyo (JP); Yuhki Mitsufuji, Tokyo (JP); Kenichi Makino, Kanagawa (JP)

(21) Appl. No.: 12/739,106

(22) PCT Filed: Aug. 28, 2009
(86) PCT No.: PCT/JP2009/065033

§ 371 Date: Apr. 21, 2010

(30) Foreign Application Priority Data
Aug. 29, 2008 (JP) 2008-221655

(51) Int. Cl. H04B 1/10

(52) U.S. Cl. 704/500

(57) ABSTRACT

The present invention relates to a frequency band extension apparatus and method, an encoding apparatus and method, a decoding apparatus and method, and a program, with which a music signal can be reproduced with higher sound quality by means of frequency band extension.

Band-pass filters 13 obtain a plurality of subband signals from an input signal. A frequency envelope extracting circuit 14 extracts a frequency envelope from the plurality of subband signals obtained by the plurality of band-pass filters. A highband signal generating circuit 15 generates highband signal components on the basis of the frequency envelope obtained by the frequency envelope extracting circuit 14, and the plurality of subband signals obtained by the band-pass filters 13. A frequency band extension apparatus 10 extends the frequency band of the input signal on the basis of the highband signal components generated by the highband signal generating circuit 15. The present invention can be applied to, for example, a frequency band extension apparatus, an encoding apparatus, a decoding apparatus, and the like.

### TECHNICAL FIELD

The present invention relates to a frequency band extension apparatus and method, an encoding apparatus and method, a decoding apparatus and method, and a program, in particular, a frequency band extension apparatus and method, an encoding apparatus and method, a decoding apparatus and method, and a program, with which a music signal can be reproduced with higher sound quality by means of frequency band extension.

### BACKGROUND ART

In recent years, music distribution services for distributing music data via the Internet or the like are becoming widely available. In these music distribution services, encoded data obtained by encoding a music signal is distributed as music data. As the technique for encoding a music signal, encoding techniques have become mainstream which limit the file size of encoded data to reduce the bit rate so that it does not take much time when downloading.

Roughly divided, as such music signal encoding techniques, there exist an encoding technique such as MP3 (MPEG (Moving Picture Experts Group) Audio Layer3) (International Standard ISO/IEC 11172-3), and an encoding technique such as HE-AAC (High Efficiency MPEG4 AAC) (International Standard ISO/IEC 14496-3).

In the encoding technique typified by MP3, the signal components of a music signal in the high frequency band (hereinafter, referred to as highband) of about 15 kHz or above which can be hardly perceived by human ears are cut, and the remaining signal components in the low frequency band (hereinafter, referred to as lowband) are encoded. Such an encoding technique is hereinafter referred to as highband-cutting encoding technique. This highband-cutting encoding technique makes it possible to limit the file size of encoded data. However, since sounds in the highband can be perceived, albeit slightly, by humans, when a sound is generated and outputted from a decoded music signal obtained by decoding the encoded data, it is often the case that sound quality degradation occurs, such as loss of the sense of realism that the original signal has, and muffled sound.

In contrast, in the encoding technique typified by HE-AAC, characteristic information is extracted from signal components in the highband, and encoded together with signal components in the lowband. Such an encoding technique is hereinafter referred to as highband-characteristics encoding technique. Since this highband-characteristics encoding technique encodes only characteristic information of the signal components in the highband as information related to the signal components in the highband, the encoding efficiency can be improved while suppressing degradation of sound quality.

In decoding encoded data encoded by this highband-characteristics encoding technique, the signal components in the lowband and characteristic information are decoded, and signal components in the highband are generated from the signal components in the lowband and the characteristic information that have been decoded. Hereinafter, the technique of extending the frequency band of the signal components in the lowband by generating the signal components in the highband from the signal components in the lowband in this way is referred to as band extension technique.

An example of application of this band extension technique is post-processing performed after decoding of data encoded by the highband-cutting encoding technique mentioned above. In this post-processing, the signal components in the highband lost by encoding are generated from the decoded signal components in the lowband, thereby extending the frequency band of the signal components in the lowband (see, for example, Patent Literature 1). It should be noted that the frequency band extension technique in Patent Literature 1 is hereinafter referred to as band extension technique in Patent Literature 1.

According to the band extension technique in Patent Literature 1, with the decoded signal components in the lowband as an input signal, the apparatus estimates the power spectrum of the highband (hereinafter, referred to as frequency envelope of the highband) from the power spectrum of the input signal, and generates signal components in the highband having the frequency envelope of the highband from the signal components in the lowband.

FIG. 1 shows an example of the power spectrum of the decoded lowband as an input signal, and the estimated frequency envelope of the highband.

In FIG. 1, the vertical axis represents power by logarithm, and the horizontal axis represents frequency.

The apparatus determines the band at the low end of signal components in the highband (hereinafter, referred to as extension start band) from information related to an input signal, such as the kind of encoding scheme, sampling rate, and bit rate (hereinafter, referred to as side information). Next, the apparatus divides the input signal as signal components in the lowband into a plurality of subband signals. The apparatus finds the average for each group (hereinafter, referred to as group power) with respect to the temporal direction of the respective powers of the plurality of divided subband signals, that is, the plurality of subband signals on the side lower than the extension start band (hereinafter, simply referred to as lowband side). As shown in FIG. 1, the apparatus obtains the average of the respective group powers of the plurality of subband signals on the lowband side as power, and obtains the point at which the frequency equals the frequency at the low end of the extension start band as a starting point. The apparatus estimates a first-order linear line with a predetermined slope passing through the starting point, as the frequency envelope on the side higher than the extension start band (hereinafter, simply referred to as highband side). It should be noted that the position of the starting point with respect to the power direction can be adjusted by the user. The apparatus generates each of a plurality of subband signals on the highband side from the plurality of subband signals on the lowband side, so that the estimated frequency envelope on the highband side is obtained. The apparatus adds the plurality of generated subband signals on the highband side to obtain signal components in the highband, and further adds the signal components in the lowband and outputs the result. Thus, the frequency-band-extended music signal becomes closer to the original music signal. Hence, it is possible to reproduce a music signal with higher sound quality.

The band extension technique in Patent Literature 1 described above has an advantage in that, for data encoded by various highband-cutting encoding techniques or at various bit rates, the frequency band can be extended with respect to the music signal obtained after decoding the encoded data.

### CITATION LIST

### Patent Literature

PTL 1: Japanese Unexamined Patent Application Publication No. 2008-139844

### SUMMARY OF INVENTION

### Technical Problem

However, the band extension technique in Patent Literature 1 leaves a room for improvement in that the estimated frequency envelope on the highband side is a first-order linear line with a predetermined slope, that is, the shape of the frequency envelope is fixed.

That is, the power spectrum of a music signal has various shapes. Depending on the kind of music signal, it is not infrequent when the shape greatly deviates from the frequency envelope on the highband side which is estimated by the band extension technique in Patent Literature 1.

FIG. 2 shows an example of the original power spectrum of a music signal with attack property accompanying sudden temporal changes.

It should be noted that, with the signal components on the lowband side of the music signal with attack property as an input signal, FIG. 2 also shows the frequency envelope on the highband side estimated from the input signal.

As shown in FIG. 2, the original power spectrum on the highband side of the music signal with attack property is substantially flat.

In contrast, the estimated frequency envelope on the highband side has a predetermined negative slope, and even if an adjustment is made at the starting point to a power closer to the original power spectrum, the difference from the original power spectrum becomes greater as the frequency becomes higher.

As described above, with the band extension technique in Patent Literature 1, the estimated frequency envelope on the highband side cannot replicate the original frequency envelope on the highband side with high accuracy. As a result, when sound is generated from the frequency-band-extended music signal and outputted, sometimes the clarity of sound is lost from the original sound in terms of the auditory sensation.

Also, in the encoding technique such as HE-AAC mentioned above, the frequency envelope on the highband side is used as characteristic information of the signal components in the highband to be encoded. However, if the original frequency envelope on the highband side can be replicated with high accuracy at the decoding side, then the encoding of characteristic information of the signal components in the highband itself becomes unnecessary. This leads to a further improvement in encoding efficiency.

The present invention has been made in view of the above circumstances, and its object is to allow a music signal to be reproduced with higher sound quality by means of frequency band extension.

### Solution to Problem

A frequency band extension apparatus according to an aspect of the present invention includes: a plurality of band-pass filters that obtain a plurality of subband signals from an input signal; a frequency envelope extracting circuit that extracts a frequency envelope from the plurality of subband signals obtained by the plurality of band-pass filters; and a highband signal generating circuit that generates highband signal components, on the basis of the frequency envelope obtained by the frequency envelope extracting circuit, and the plurality of subband signals obtained by the band-pass filters, in which a frequency band of the input signal is extended by using the highband signal components generated by the highband signal generating circuit.

The frequency envelope extracting circuit obtains a first-order slope of the frequency envelope from the plurality of subband signals obtained by the plurality of band-pass filters.

In the frequency envelope extracting circuit, when extracting the frequency envelope from the plurality of subband signals obtained by the plurality of band-pass filters, powers of the plurality of subband signals are used.

In the frequency envelope extracting circuit, when extracting the frequency envelope from the plurality of subband signals obtained by the plurality of band-pass filters, amplitudes of the plurality of subband signals are used.

In the frequency envelope, a calculation segment for the frequency envelope varies depending on steadiness of the input signal.

The frequency envelope extracting circuit obtains a plurality of first-order slopes of the frequency envelope from the plurality of subband signals obtained by the plurality of band-pass filters.

The highband signal generating circuit includes a gain calculating circuit that finds a gain for each subband from the frequency envelope obtained by the frequency envelope extracting circuit, and applies the gain to the plurality of subband signals obtained by the plurality of band-pass filters.

The gain calculating circuit finds the gain for each subband from the frequency envelope calculated in each of a plurality of blocks on a temporal axis.

The first-order slope of the frequency envelope is computed in a weighted manner from the plurality of subband signals obtained by the plurality of band-pass filters.

In the gain calculating circuit, the gain is computed by a mapping function obtained by performing learning in advance with a wide-band signal as teacher data.

The mapping function has a first-order slope as input and the gain as output.

The mapping function has each of a plurality of first-order slopes as input and the gain as output.

The mapping function has a first-order slope on a logarithmic scale as input and the gain on a logarithmic scale as output.

The frequency band extension apparatus further includes a highband-subband-strength generating circuit that generates strengths of individual highband subbands in a frequency extension band from the plurality of subband signals obtained by the plurality of band-pass filters.

The highband-subband-strength generating circuit computes the strengths of the individual highband subbands in the frequency extension band from linear combination of strengths of the plurality of subband signals obtained by the plurality of band-pass filters.

The highband-subband-strength generating circuit computes the strengths of the individual highband subbands in the frequency extension band from linear combination of a plurality of subband signal strengths calculated in a plurality of blocks on a temporal axis.

The highband-subband-strength generating circuit computes the strengths of the individual highband subbands in the frequency extension band, by using the plurality of subband signal strengths calculated in the plurality of blocks on the temporal axis which are substituted by a single variable for each subband.

The highband-subband-strength generating circuit computes the strengths of the individual highband subbands in the frequency extension band by using a non-linear function from strengths of the plurality of subband signals obtained by the plurality of band-pass filters.

The highband-subband-strength generating circuit computes the strengths of the individual highband subbands in the frequency extension band by using a non-linear function from a plurality of subband signal strengths calculated in a plurality of blocks on a temporal axis.

The non-linear function is a function of an arbitrary order.

Input and output of the highband-subband-strength generating circuit are powers of the plurality of subband signals obtained by the plurality of band-pass filters, and powers of the highband subbands, respectively.

Input and output of the highband-subband-strength generating circuit are amplitudes of the plurality of subband signals obtained by the plurality of band-pass filters, and amplitudes of the highband subbands, respectively.

In the gain calculating circuit, the gain is computed by a mapping function having coefficients obtained by performing learning in advance with a wide-band signal as teacher data.

A frequency band extension method according to an aspect of the present invention includes a frequency band extending apparatus: obtaining a plurality of subband signals from an input signal; extracting a frequency envelope from the obtained plurality of subband signals; generating highband signal components on the basis of the extracted frequency envelope, and the obtained plurality of subband signals; and extending a frequency band of the input signal by using the generated highband signal components.

A program according to an aspect of the present invention causes a computer controlling a frequency band extension apparatus to execute a control process including the steps of: obtaining a plurality of subband signals from an input signal; extracting a frequency envelope from the obtained plurality of subband signals; generating highband signal components on the basis of the extracted frequency envelope, and the obtained plurality of subband signals; and extending a frequency band of the input signal by using the generated highband signal components.

In a frequency band extension apparatus and method, and a program according to an aspect of the present invention, a plurality of subband signals are obtained from an input signal, a frequency envelope is extracted from the obtained plurality of subband signals, highband signal components are generated on the basis of the extracted frequency envelope, and the obtained plurality of subband signals, and a frequency band of the input signal is extended by using the generated highband signal components.

An encoding apparatus according to an aspect of the present invention includes: a subband division circuit that divides an input signal into a plurality of subbands, and generates lowband subband signals including a plurality of subbands on a lowband side, and highband subband signals including a plurality of subbands on a highband side; a lowband encoding circuit that encodes the lowband subband signals, and generates lowband encoded data; a frequency envelope extracting circuit that extracts a frequency envelope from the lowband subband signals; a pseudo-highband-signal generating circuit that generates pseudo highband signals, from the frequency envelope obtained by the frequency envelope extracting circuit and the lowband subband signals; a pseudo-highband-signal-correction-information calculating circuit that compares the highband subband signals obtained by the subband division circuit with the pseudo highband signals generated by the pseudo-highband-signal generating circuit, and obtains pseudo-highband-signal correction information; a highband encoding circuit that encodes the pseudo-highband-signal correction information, and generates highband encoded data; and a multiplexing circuit that multiplexes the lowband encoded data generated by the lowband encoding circuit and the highband encoded data generated by the highband encoding circuit to obtain an output code string.

An encoding method according to an aspect of the present invention includes the steps of a signal encoding apparatus: dividing an input signal into a plurality of subbands, and generating lowband subband signals including a plurality of subbands on a lowband side, and highband subband signals including a plurality of subbands on a highband side; encoding the lowband subband signals, and generating lowband encoded data; extracting a frequency envelope from the lowband subband signals; generating pseudo highband signals from the extracted frequency envelope and the lowband subband signals; comparing the highband subband signals with the generated pseudo highband signals, and obtaining pseudo-highband-signal correction information; encoding the pseudo-highband-signal correction information, and generating highband encoded data; and multiplexing the generated lowband encoded data and the generated highband encoded data to obtain an output code string.

A program according to an aspect of the present invention includes the steps of a computer that controls a signal encoding apparatus: dividing an input signal into a plurality of subbands, and generating lowband subband signals including a plurality of subbands on a lowband side, and highband subband signals including a plurality of subbands on a highband side; encoding the lowband subband signals, and generating lowband encoded data; extracting a frequency envelope from the lowband subband signals; generating pseudo highband signals from the extracted frequency envelope and the lowband subband signals; comparing the highband subband signals with the generated pseudo highband signals, and obtaining pseudo-highband-signal correction information; encoding the pseudo-highband-signal correction information, and generating highband encoded data; and multiplexing the generated lowband encoded data and the generated highband encoded data to obtain an output code string.

In an encoding apparatus and method, and a program according to an aspect of the present invention, an input signal is divided into a plurality of subbands to generate lowband subband signals including a plurality of subbands on a lowband side, and highband subband signals including a plurality of subbands on a highband side, the lowband subband signals are encoded to generate lowband encoded data, a frequency envelope is extracted from the lowband subband signals, pseudo highband signals are generated from the extracted frequency envelope and the lowband subband signals, the highband subband signals are compared with the generated pseudo highband signals to obtain pseudo-highband-signal correction information, the pseudo-highband-signal correction information is encoded to generate highband encoded data, and the generated lowband encoded data and the generated highband encoded data are multiplexed to obtain an output code string.

A decoding apparatus according to an aspect of the present invention includes: a demultiplexing circuit that demultiplexes inputted encoded data, and generates lowband encoded data and highband encoded data; a lowband decoding circuit that decodes the lowband encoded data, and generates lowband subband signals; a frequency envelope extracting circuit that extracts a frequency envelope from a plurality of subband signals of the lowband subband signals; a pseudo-highband-signal generating circuit that generates pseudo highband signals, from the frequency envelope obtained by the frequency envelope extracting circuit and the lowband subband signals; a highband decoding circuit that decodes the highband encoded data, and generates pseudo-highband-signal correction information; and a pseudo-highband-signal correcting circuit that corrects the pseudo highband signals by using the pseudo-highband-signal correction information to generate corrected pseudo highband signals.

A decoding method according to an aspect of the present invention includes the steps of a decoding apparatus: demultiplexing inputted encoded data, and generating lowband encoded data and highband encoded data; decoding the lowband encoded data, and generating lowband subband signals; extracting a frequency envelope from a plurality of subband signals of the lowband subband signals; generating pseudo highband signals from the extracted frequency envelope and the lowband subband signals; decoding the highband encoded data, and generating pseudo-highband-signal correction information; and correcting the pseudo highband signals by using the pseudo-highband-signal correction information to generate corrected pseudo highband signals.

A computer according to an aspect of the present invention includes the steps of a computer that controls a decoding apparatus: demultiplexing inputted encoded data, and generating lowband encoded data and highband encoded data; decoding the lowband encoded data, and generating lowband subband signals; extracting a frequency envelope from a plurality of subband signals of the lowband subband signals; generating pseudo highband signals from the extracted frequency envelope and the lowband subband signals; decoding the highband encoded data, and generating pseudo-highband-signal correction information; and correcting the pseudo highband signals by using the pseudo-highband-signal correction information to generate corrected pseudo highband signals.

In a decoding apparatus and method, and a program according to an aspect of the present invention, inputted encoded data is demultiplexed to generate lowband encoded data and highband encoded data, the lowband encoded data is decoded to generate lowband subband signals, a frequency envelope is extracted from a plurality of subband signals of the lowband subband signals, pseudo highband signals are generated from the extracted frequency envelope and the lowband subband signals, the highband encoded data is decoded to generate pseudo-highband-signal correction information, and the pseudo highband signals are corrected by using the pseudo-highband-signal correction information to generate corrected pseudo highband signals.

### Advantageous Effects of Invention

According to an aspect of the present invention, a music signal can be reproduced with higher sound quality by means of frequency band extension.

### BRIEF DESCRIPTION OF DRAWINGS

FIG. 1 is a diagram showing an example of the power spectrum of the decoded lowband as an input signal, and an estimated frequency envelope of the highband.

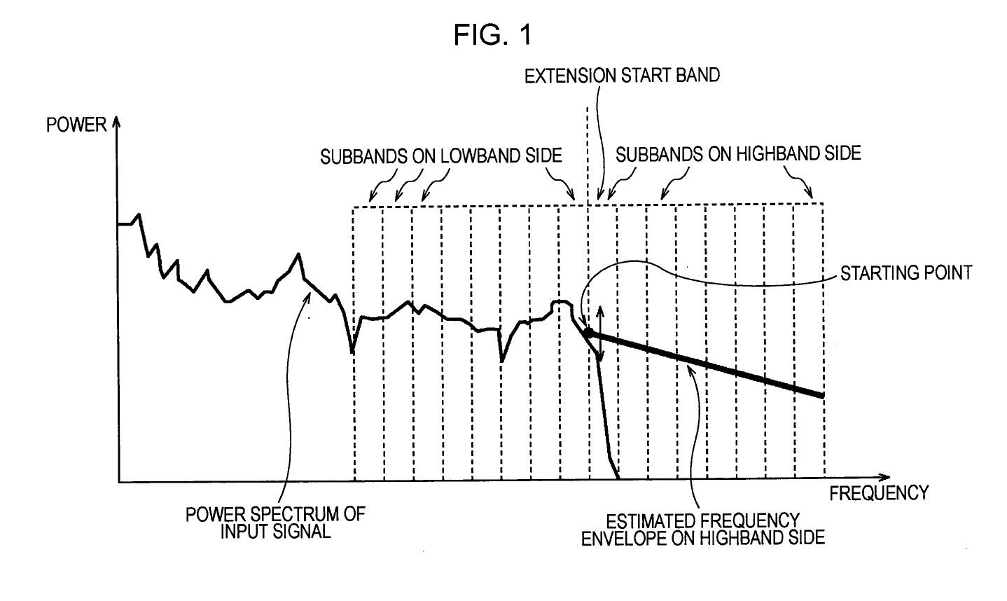

FIG. 2 is a diagram showing an example of the original power spectrum of a music signal with attack property accompanying sudden temporal changes.

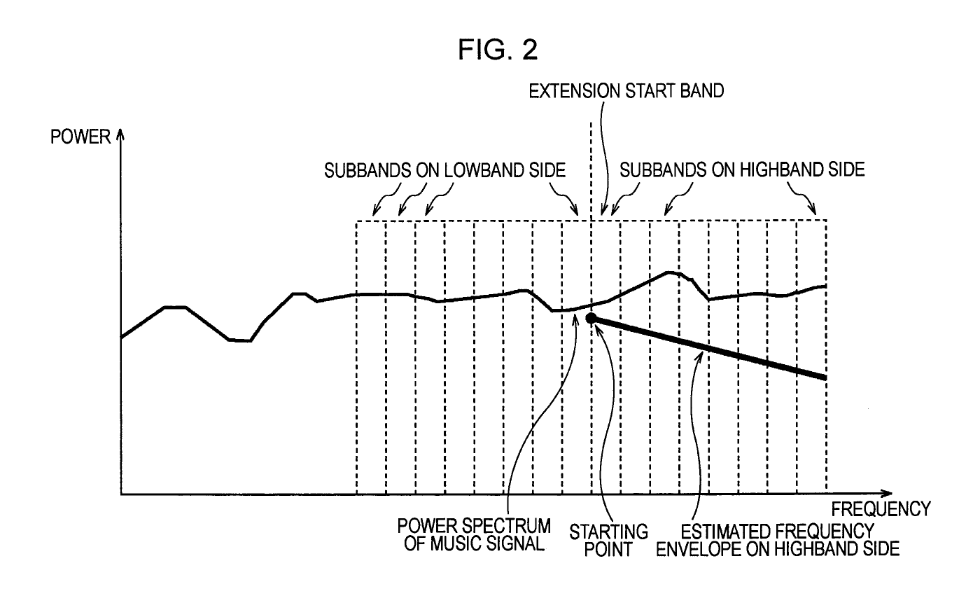

FIG. 3 is a functional block diagram showing an example of the functional configuration of a frequency band extension apparatus according to a first embodiment based on the present invention.

FIG. 4 is a flowchart illustrating an example of a frequency band extension process by the frequency band extension apparatus in FIG. 3.

FIG. 5 is a diagram showing the spectrum of a signal inputted to the frequency band extension apparatus in FIG. 3, and the placement of band-pass filters on the frequency axis.

FIG. 6 is a functional block diagram showing an example of the functional configuration of a coefficient learning apparatus for performing learning of coefficients used in a highband signal generating circuit of the frequency band extension apparatus in FIG. 3.

FIG. 7 is a diagram showing the spectrum of a wide-band teacher signal inputted to the coefficient learning apparatus in FIG. 6, and the placement of band-pass filters on the frequency axis.

FIG. 8 is a diagram showing the waveform of a given time-series signal.

FIG. 9 is a diagram showing an example in which short time frames are applied to an unsteady frame.

FIG. 10 is a functional block diagram showing an example of the functional configuration of a frequency band extension apparatus according to a second embodiment based on the present invention.

FIG. 11 is a functional block diagram showing an example of the functional configuration of an encoding apparatus according to a third embodiment based on the present invention.

FIG. 12 is a flowchart illustrating an example of an encoding process by the encoding apparatus in FIG. 11.

FIG. 13 is a diagram showing an example of code string outputted by the encoding apparatus in FIG. 11.

FIG. 14 is a functional block diagram showing an example of the functional configuration of a decoding apparatus according to the third embodiment based on the present invention.

FIG. 15 is a flowchart illustrating an example of a decoding process by the decoding apparatus in FIG. 14.

FIG. 16 is a diagram showing another example of code string outputted by the encoding apparatus in FIG. 11.

FIG. 17 is a block diagram showing an example of the hardware configuration of a computer that executes processes to which the present invention is applied.

### DESCRIPTION OF EMBODIMENTS

Hereinbelow, embodiments to which the present invention is applied will be described with reference to the drawings.

1. First Embodiment (case in which the present invention is applied to a frequency band extension apparatus)

2. Second Embodiment (case in which the present invention is applied to a frequency band extension apparatus)

3. Third Embodiment (case in which the present invention is applied to an encoding apparatus and a decoding apparatus)

### First Embodiment

First, a first embodiment will be described.

In the first embodiment, with respect to decoded signal components in the lowband obtained by decoding data encoded by the highband-cutting encoding technique mentioned above, a process of extending the frequency band (hereinafter, referred to frequency band extension process) is applied.

### Example of Functional Configuration of Frequency Band Extension Apparatus According to First Embodiment

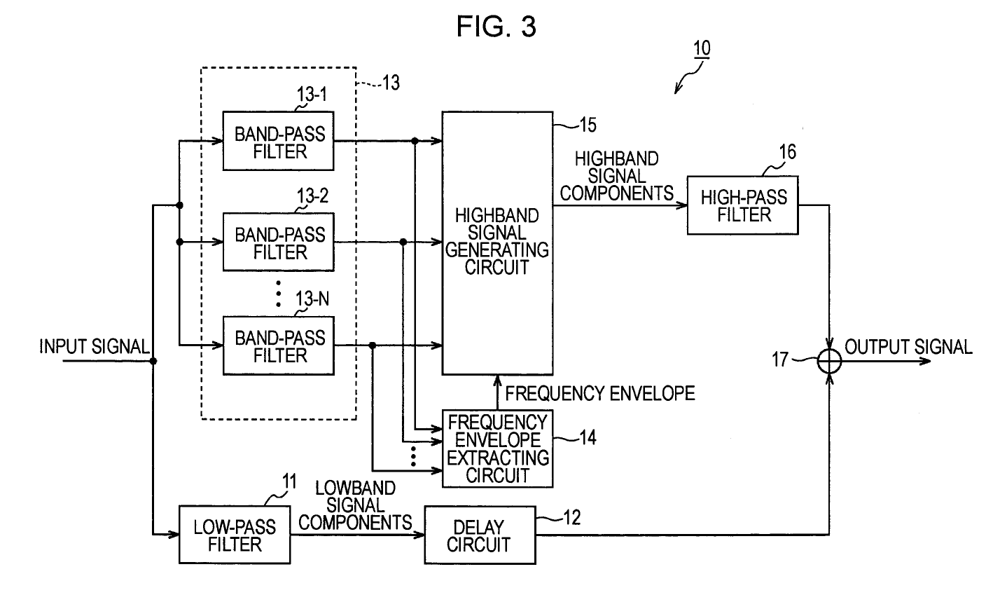

FIG. 3 shows an example of the functional configuration of a frequency band extension apparatus to which the present invention is applied.

A frequency band extension apparatus 10 applies, with decoded signal components in the lowband as an input signal, a frequency band extension process to the input signal, and outputs the frequency-band-extended music signal obtained as a result, as an output signal.

The frequency band extension apparatus 10 includes a low-pass filter 11, a delay circuit 12, band-pass filters 13, a frequency envelope extracting circuit 14, a highband signal generating circuit 15, a high-pass filter 16, and a signal adder 17.

### Example of Processing in Frequency Band Extension Apparatus According to First Embodiment

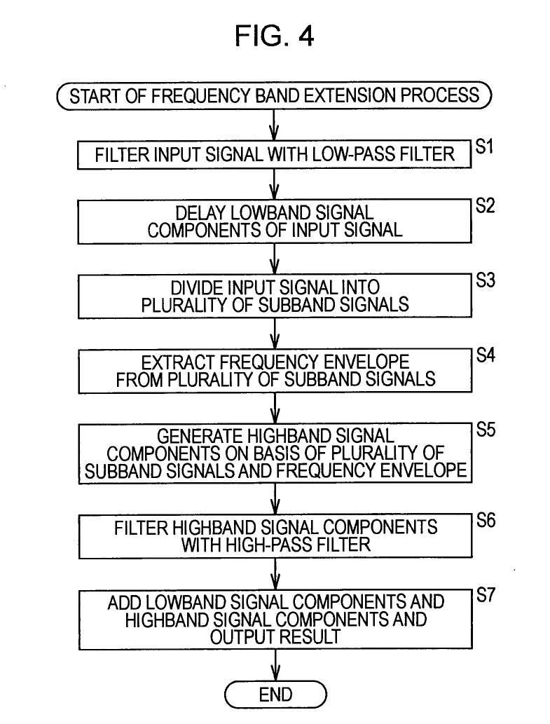

FIG. 4 is a flowchart illustrating an example of processing in the frequency band extension apparatus in FIG. 3 (hereinafter, referred to as frequency band extension process).

In step S1, the low-pass filter 11 applies filtering to an input signal with a low-pass filter having a predetermined cut-off frequency, and supplies the filtered signal to the delay circuit 12.

For the low-pass filter 11, an arbitrary frequency can be set as the cut-off frequency. It should be noted, however, that in this embodiment, with a predetermined band described later as an extension start band, the cut-off frequency is set in correspondence to the frequency at the lower end of the extension start band. Accordingly, the low-pass filter 11 supplies, as the filtered signal, signal components in the band lower than the extension start band (hereinafter, referred to as lowband signal components), to the delay circuit 12.

Also, for the low-pass filter 11, an optimal frequency can be set as the cut-off frequency in accordance with the highband-cutting encoding technique for the input signal, and encoding parameters such as the bit rate. As such encoding parameters, for example, the side information employed in the band extension technique in Patent Literature 1 may be used.

In step S2, in order to ensure synchronization when adding the lowband signal components and highband signal components described later, the delay circuit 12 delays the lowband signal components by a predetermined delay time, and supplies the result to the signal adder 17.

In step S3, the band-pass filters 13 divide the input signal into a plurality of subband signals, and supply each of the plurality of divided subband signals to the frequency envelope extracting circuit 14 and the highband signal generating circuit 15.

That is, the band-pass filters 13 include band-pass filters 13-1 to 13-N having different pass-bands. A pass-band filter 13-i (1≦i≦N) passes a signal of a pass-band out of the input signal, and outputs the passed signal as predetermined one of the plurality of subband signals.

In step S4, the frequency envelope extracting circuit 14 extracts a frequency envelope from the plurality of subband signals from the band-pass filters 13, and supplies the frequency envelope to the highband signal generating circuit 15.

In step S5, the highband signal generating circuit 15 generates highband signal components, on the basis of the plurality of subband signals from the band-pass filters 13 and the frequency envelope from the frequency envelope extracting circuit 14. Highband signal components refer to signal components in the band higher than the extension start band.

The high-pass filter 16 is configured as a high-pass filter having a cut-off frequency corresponding to the cut-off frequency in the low-pass filter 11. Accordingly, in step S6, the high-pass filter 16 applies filtering to the highband signal components from the highband signal generating circuit 15 with a high-pass filter to remove noise such as components aliasing back into the lowband contained in the highband signal components, and supplies the result to the signal adder 17.

In step S7, the signal adder 17 adds the lowband signal components from the delay circuit 12, and the highband signal components from the high-pass filter 16 together, and outputs the signal obtained after the addition to the subsequent stages as an output signal.

In this embodiment, the band-pass filters 13 are adopted for acquiring subband signals. However, the filter configuration for acquiring subband signals is not particularly limited to the example in FIG. 3. For example, as another embodiment, a band-dividing filter such as one described in Patent Literature 1 may be adopted.

Also, in this embodiment, the signal adder 17 is adopted for synthesizing subband signals. However, the configuration for synthesizing subband signals is not particularly limited to the example in FIG. 3. For example, as another embodiment, a band synthesis filter such as one described in Patent Literature 1 may be adopted.

Next, a description will be given of a detailed example of processing in each of the band-pass filters 13 to the highband signal generating circuit 15.

### Detailed Example of Processing in Band-Pass Filters 13

First, an example of processing in the band-pass filters 13 will be described.

It should be noted that for the convenience of description, in the following description, it is assumed that the number N of band-pass filters 13=8.

For example, one of 32 subbands obtained by dividing the Nyquist frequency of an input signal into 32 equal parts is adopted as an extension start band, and among the 32 subbands, predetermined eight subbands lower than the extension start band are adopted as the respective pass-bands of eight band-pass filters 13-1 to 13-8.

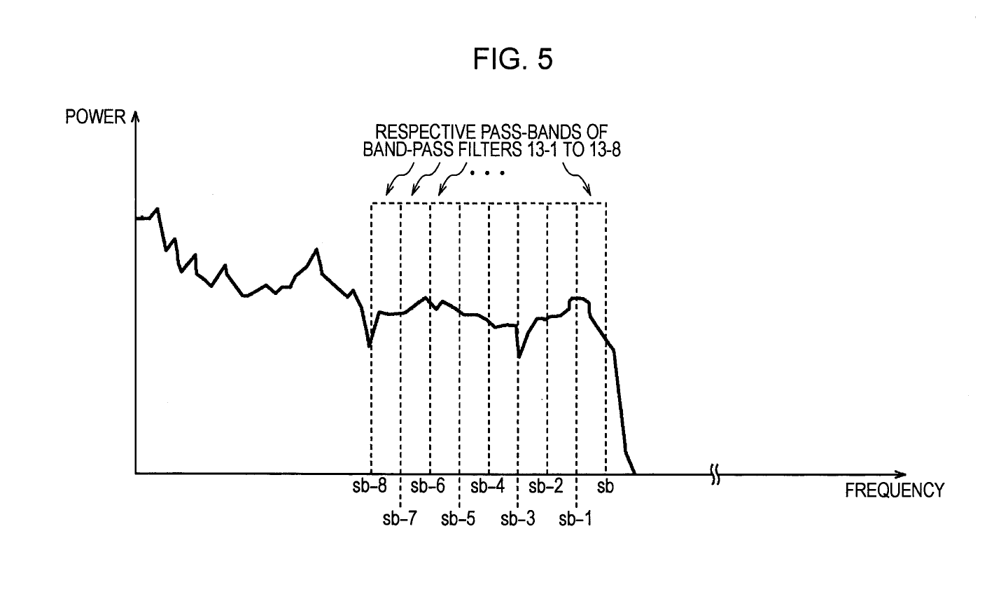

FIG. 5 shows the placement of the respective pass-bands of the eight band-pass filters 13-1 to 13-8 on the frequency axis.

As shown in FIG. 5, as the respective pass-bands of the eight band-pass filters, the first subband sb−1 to the eighth subband signal sb−8 from the highest of the frequency bands (subbands) lower than the extension start band are respectively assigned. It should be noted that frequency sb is the subband at the lower end of the extension start band. Thus, hereinafter, these eight subbands are expressed by using sb for their differentiation from others.

It should be noted that in this embodiment, the respective pass-bands of the eight band-pass filters 13-1 to 13-8 are eight predetermined subbands of the 32 subbands obtained by dividing the Nyquist frequency of an input signal into 32 equal parts. However, the band-pass filters 13 are not limited to this example. For example, the respective pass-bands of the eight band-pass filters 13-1 to 13-8 may be eight predetermined subbands of 256 subbands obtained by dividing the Nyquist frequency of an input signal into 256 equal parts. Also, the respective bandwidths of the eight band-pass filters 13-1 to 13-8 may differ from each other.

### Example of Processing in Frequency Envelope Extracting Circuit 14

Next, an example of processing in the frequency envelope extracting circuit 14 will be described.

The frequency envelope extracting circuit 14 extracts a frequency envelope from a plurality of subband signals outputted by the band-pass filters 13. Accordingly, in the following, as an embodiment of processing in the frequency envelope extracting circuit 14, a description will be given of an example in which the first-order slope of a frequency envelope is used as a frequency envelope.

First, the frequency envelope extracting circuit 14 finds the power in a given predetermined time frame, from the eight subband signals x (ib, n) sb−8 to sb−1 outputted by the band-pass filters 13. Here, ib denotes the index of a subband, and n denotes the index of discrete time.

Letting the power of a subband signal with respect to a subband ib in a given time frame number J be described as power (ib, J), power (ib, J) is represented by Equation (1) below.

$$\begin{matrix}[ Eq . 1 ] & \\ power ( ib , J ) = {\sum }_{n = J * FSIZE}^{( J + 1 ) * FSIZE - 1} \{ x ( ib , n ) * x ( ib , n ) \} \\ ( sb - 8 ≦ ib ≦ sb - 1 ) & ( 1 )\end{matrix}$$

By using this power(ib, J), the first-order slope slope(J) of a frequency envelope in the given time frame number J is represented by Equation (2) below.

$$\begin{matrix} [ Eq . 2 ] & \\ slope ( J ) = 10 * {log}_{10} [ {\sum }_{ib = sb - 8}^{sb - 1} \{ W ( ib - sb + 8 ) * power ( ib , J ) \} / \{ {\sum }_{ib = sb - 8}^{sb - 1} \{ W ( sb - 1 - ib ) * power ( ib , J ) ] \} ] & ( 2 )\end{matrix}$$

In Equation (2), W(ib) denotes a weighting coefficient with respect to the subband ib. By finding the slope(J) by using this weighting coefficient W(ib), it is possible to mitigate the influence of loss of a specific subband signal component due to encoding. It should be noted that details about the influence of loss of a specific subband signal component due to encoding are described in Patent Literature 1 mentioned above.

As described above, in this example, the first-order slope slope(J) of a frequency envelope is found by using the power of each subband signal. However, the method of finding the first-order slope slope(J) of a frequency envelope is not limited to the finding method using power. Alternatively, for example, the first-order slope slope(J) of a frequency envelope can be also found by using the amplitude of each subband signal.

Also, the frequency envelope extracting circuit 14 may obtain a plurality of first-order slopes of a frequency envelope from a plurality of subband signals outputted by the band-pass filters 13.

### Example of Processing in Highband Signal Generating Circuit 15

Next, an example of processing in the highband signal generating circuit 15 will be described.

The highband signal generating circuit 15 generates highband signal components, on the basis of a plurality of subband signals outputted from the band-pass filters 13 and a frequency envelope outputted from the frequency envelope extracting circuit 14. Accordingly, in the following, as an embodiment of the highband signal generating circuit 15, a description will be given of an example in which highband components are generated with the first-order slope of a frequency envelope described above as a frequency envelope.

First, the highband signal generating circuit 15 sets each of subband signals in the band to be extended from the extension start frequency band sb (hereinafter, referred to as frequency extension band) as a mapping target subband signal. Also, the highband signal generating circuit 15 sets a predetermined one subband signal of a plurality of subband signals outputted from the band-pass filters 13 corresponding to the mapping target subband signal, as a mapping source. The highband signal generating circuit 15 computes (estimates) the gain G(ib, J) of the mapping target subband signal with respect to the mapping source subband signal by using the first-order slope slope(J) of a frequency envelope. This gain G(ib, J) is represented by Equation (3) below, as a linear transformation of a first-order equation on a logarithmic scale with respect to the first-order slope slope(J) of a frequency envelope.

[Eq. 3]

G(ib,J)=10^{{(α}^{_{ib}}*^{slope(J)+β}^{_{ib}}^{)/20}} (3)

In Equation (3), α_{ib} and β_{ib} are coefficients having different values for every ib. It is preferable that each of the coefficients α_{ib} and β_{ib} be set appropriately so that preferable G(ib, J) can be obtained with respect to various input signals. Also, it is preferable to change each of the coefficients α_{ib} and β_{ib} to an optimal value with a change of sb. It should be noted that a specific example of the technique of computing each of the coefficients α_{ib} and β_{ib} will be described later.

As described above, in this example, the gain G(ib, J) is computed by using a first-order equation on a logarithmic scale with respect to the slope(J). However, the method of finding the gain G(ib, J) is not limited to the method using a first-order equation. Alternatively, for example, if there are enough calculation resources available, the gain G(ib, J) can be computed by using an nth-order equation on a logarithmic scale with respect to the slope(J). Furthermore, not only continuous or curved line function approximation but also a codebook can be used to compute the gain G(ib, J) from a frequency envelope.

Further, the gain G(ib, J) may be in the form of a function having each of a plurality of first-order slopes of a frequency envelope as input, and a gain as output.

Next, by using Equation (4) below, the highband signal generating circuit 15 multiplies the gain G(ib, J) obtained by Equation (3) by the outputs of the band-pass filters 13, thereby computing gain-adjusted subband signals x2(ib, n).

[Eq. 4]

x2(ib,n)=G(ib,J)*x(sbₘₐₚ(ib),n)(J*FSIZE≦n≦(J+1)*FSIZE−1,sb≦ib≦eb) (4)

In Equation (4), eb denotes the highest subband in the frequency extension band. Also, a mapping target subband sbₘₐₚ(ib) when the subband ib is a mapping source subband is represented by Equation (5) below.

[Eq. 5]

sbₘₐₚ(ib)=ib−8*INT((ib−sb)/8+1) (5)

Here, the highband signal generating circuit 15 adds each of subband signals within each band made up of eight subbands in the frequency extension band from sb to eb.

The each band made up of eight subbands is represented as jb as follows.

jb=0 (sb<=ib<=sb+7)

jb=1 (sb+8<=ib<=sb+15)

jb=2 (sb+16<=ib<=eb)

It should be noted that the number of bands each made up of eight subbands is three in the above-mentioned example. However, it is needless to mention that the number of bands each made up of eight subbands is not limited to three.

The highband signal generating circuit 15 computes subband signals x3(jb, n) from the gain-adjusted subband signals x2(ib, n), in accordance with Equation (6) below.

$$\begin{matrix}[ Eq . 6 ] & \\ x 3 ( jb , n ) = {\sum }_{ib = sb + b * jb}^{sb + 8 * ( jb + 1 ) - 1} ( x 2 ( ib , n ) ) \\ ( J * FSIZE ≦ n ≦ ( J + 1 ) * FSIZE - 1 , sb ≦ in ≦ eb ) & ( 6 )\end{matrix}$$

Next, the highband signal generating circuit 15 performs cosine modulation from a frequency corresponding to sb−8 to a frequency corresponding to sb in accordance with Equation (7) below, thereby computing x4(jb, n) from x3(jb, n).

[Eq. 7]

x4(jb,n)=x3(jb,n)*2*cos(n*8*(jb+1)*pi/32)(J*FSIZE≦n≦(J+1)*FSIZE−1,jb-2) (7)

In Equation (7), pi denotes the circle ratio. Equation (7) means that each of the gain-adjusted subband signals x2(ib, n) is frequency-shifted toward the highband by eight subbands.

Next, in accordance with Equation (8) below, the highband signal generating circuit 15 computes highband signal components x_{high}(n) from x4(jb, n).

$$\begin{matrix}[ Eq . 8 ] & \\ {x}_{high} ( n ) = {\sum }_{jb = 0}^{2} x 4 ( jb , n ) & ( 8 )\end{matrix}$$

In this way, highband signal components can be generated adaptively on the basis of a frequency envelope obtained from a plurality of subband signals. Also, the strength and shape of the frequency envelope in the frequency extension band can be varied in accordance with the property of an input signal. As a result, a signal with high sound quality can be generated.

### [Method of Finding Coefficients α_{ib} and β_{ib} in Equation (3)]

Next, a description will be given of the method of finding the coefficients α_{ib} and β_{ib} in Equation (3) mentioned above.

As for the technique for finding these coefficients α_{ib} and β_{ib}, it is preferable to adopt a technique of performing learning in advance with a teacher signal of a wide band (hereinafter, referred to as wide-band teacher signal), and determining the coefficients on the basis of the result of learning, so that a preferable gain G(ib, J) can be obtained with respect to various input signals.

To perform learning of the coefficients α_{ib} and β_{ib}, a coefficient learning apparatus is adopted in which band-pass filters having the same pass-bandwidths of the band-pass filters 13-1 to 13-8 in FIG. 5 are arranged in the band higher than the extension start frequency band sb. Then, the coefficient learning apparatus performs learning after a wide-band teacher signal is inputted.

### Example of Functional Configuration of Coefficient Learning Apparatus

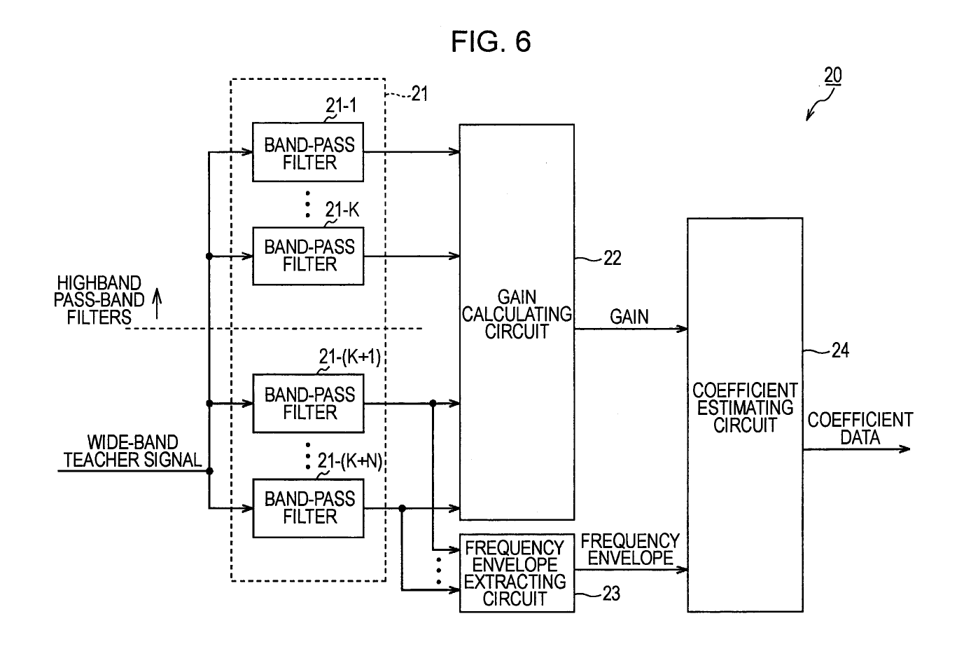

FIG. 6 shows an example of the functional configuration of a coefficient learning apparatus 20 for learning the coefficients α_{ib} and β_{ib}.

The coefficient learning apparatus 20 includes band-pass filters 21, a gain calculating circuit 22, a frequency envelope extracting circuit 23, and a coefficient estimating circuit 24.

The band-pass filters 21 include a plurality of band-pass filters 21-1 to 21-(K+N) having different pass-bands. The band-pass filters 21 divide an input signal (wide-band teacher signal) into (K+N) subband signals. The output signals of the band-pass filters 21-(K+1) to 21-(K+N), that is, a plurality of subband signals in the band lower than the extension start frequency band sb are supplied to the frequency envelope extracting circuit 23. Also, all of the output signals of the band-pass filters 21-1 to 21-(K+N), that is, all of the subband signals are supplied to the gain calculating circuit 22.

The gain calculating circuit 22 calculates, for every predetermined time frame, a gain between each subband signal in the band lower than the extension start frequency band sb, and a subband signal in the band corresponding to the frequency-shift destination for the subband signal in the band extension apparatus 10, and supplies the result to the coefficient estimating circuit 24.

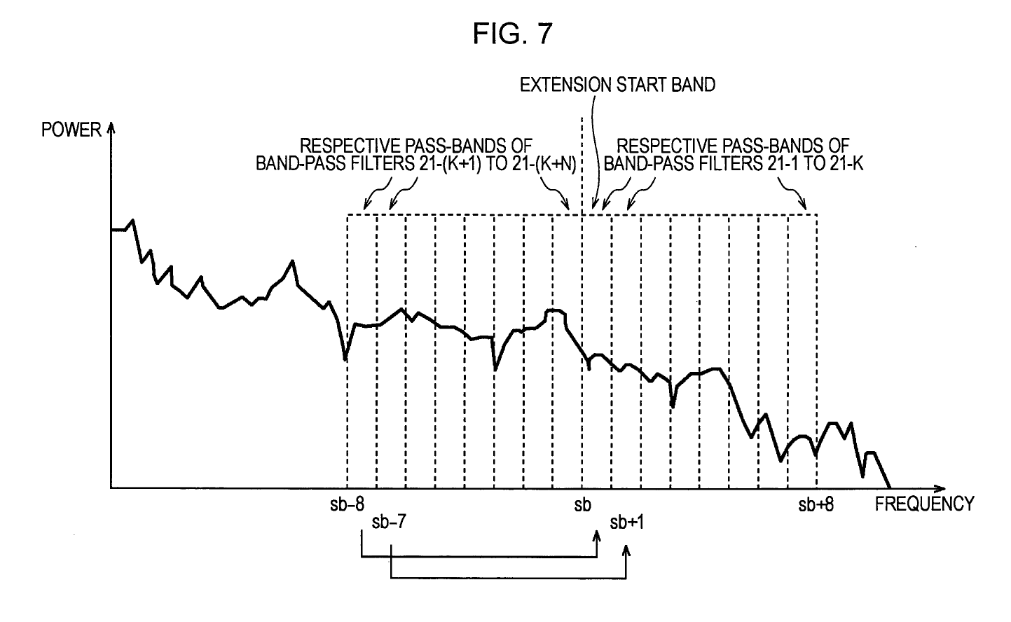

A further description will be given of the technique of calculating a gain by the gain calculating circuit 22, with reference to FIG. 7.

FIG. 7 represents the power spectrum of a wide-band signal in a time frame corresponding to the input signal shown in FIG. 5.

For example, in the example in FIG. 7, the gain is calculated between a subband signal sb−8, and a subband signal sb corresponding to the frequency-shift destination for the subband signal in the frequency band extension apparatus 10. This corresponds to the subband signal sb−8 being mapped to the subband sb after gain adjustment. Likewise, the gain is calculated between a subband signal sb−7, and a subband signal sb+1 corresponding to the frequency-shift destination for the subband signal in the frequency band extension apparatus 10. This corresponds to the subband signal sb−7 being mapped to the subband sb+1 after gain adjustment in the frequency band extension apparatus 10.

In the coefficient learning apparatus 20, as described above, the band-pass filters 21-1 to 21-K (K=8) having the same bandwidths as the band-pass filters 13-1 to 13-8 in FIG. 5 are arranged in the band higher than the extension start frequency band sb. Then, in the coefficient learning apparatus 20, a wide-band teacher signal is inputted as an input signal. Therefore, it is possible to calculate a gain G_{db}(ib, J) from these mapping source and mapping target subband signals. Specifically, for example, the gain G_{db}(ib, J) is calculated in accordance with Equation (9) below.

[Eq. 9]

G_{db}(ib,J)=10*log₁₀ [symbol] power(ib,J)/power(sbₘₐₚ(ib),J) [symbol] (9)

Returning to FIG. 6, the frequency envelope extracting circuit 23 extracts a frequency envelope from a plurality of subband signals in the same manner as the frequency envelope extracting circuit 14 in FIG. 3, for every time frame that is the same as the predetermined time frame at which a gain is calculated in the gain calculating circuit 22, and supplies the frequency envelope to the coefficient estimating circuit 24.

The coefficient estimating circuit 24 performs estimation of the coefficients α_{ib} and β_{ib} on the basis of a large number of combinations of frequency envelope and gain outputted at the same time from the gain calculating circuit 22 and the frequency envelope extracting circuit 23. Specifically, for example, for a given subband, the coefficients α_{ib} and β_{ib} in Equation (3) are determined by using the least squares method from the distribution on a two-dimensional plane on a dB scale with the frequency envelope along the z axis and the gain along the y axis. It should be noted that, as a matter of course, the technique for determining the coefficients α_{ib} and β_{ib} is not limited to the technique using the least squares method, but various kinds of common parameter identification methods may be adopted.

In this way, by performing learning in advance using a wide-band teacher signal, preferable output results can be obtained for various signals in the frequency band extension apparatus 10.

It should be noted that as the gain in a time frame J, a gain using a frequency envelope in the same time frame is adopted in the above-mentioned example. However, the gain in the time frame J is not limited to the above-mentioned example. Alternatively, for example, a gain using each of frequency envelopes in several frames preceding and following the time frame J may be adopted.

Here, for example, in the case of using the frequency envelope in each one of the immediately preceding and following frames, G(ib, J) in Equation (3) can be found as Equation (10) below.

[Eq. 10]

G(ib,J)=10^{{(α}^{_{ib,−1}}*^{slope(J-1)+α}^{_{ib,0}}*^{slope(J)+α}^{_{ib,+1}}*^{slope(J+1)+β}^{_{ib}}^{)/20}} (10)

By finding the gain G(ib, J) in this way, a higher accuracy estimation can be performed by taking variations in frequency envelope on the temporal axis into account. While this embodiment uses the frequency envelope in each one of the immediately preceding and following frames, the number of these frames can be set while taking the amount of calculation into consideration, and the present invention is not to be limited by the number of preceding and following frames.

Also, by taking the power in each one of frames preceding and following the time frame J, or the like into account, gains computed by using different mapping functions separately for steady/unsteady cases may be adopted. Also, by taking steady/unsteady into account to adaptively change the time interval FSIZE at which the power and frequency envelope are calculated, it is possible to calculate an optimum gain.

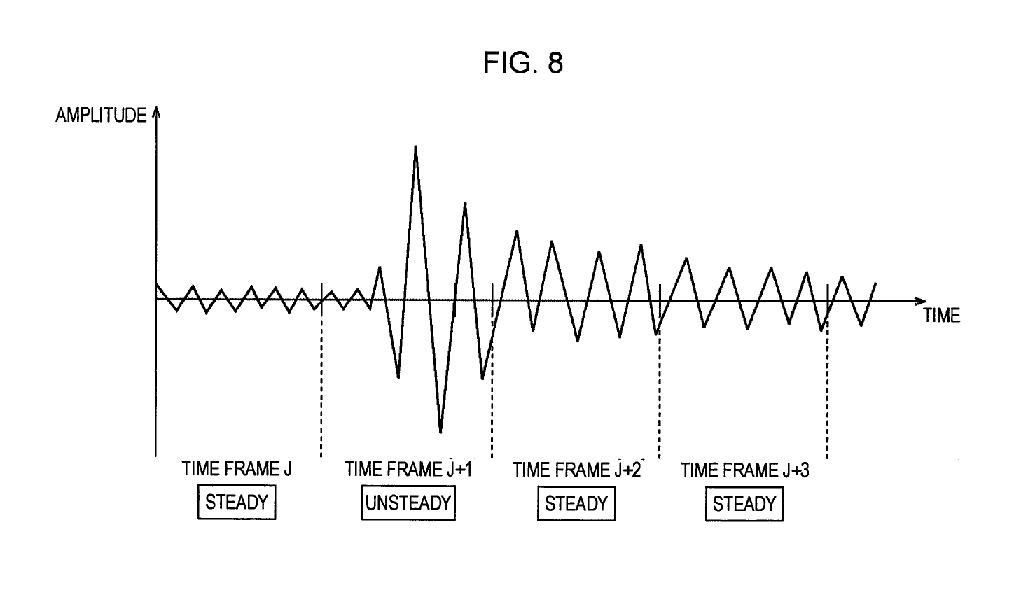

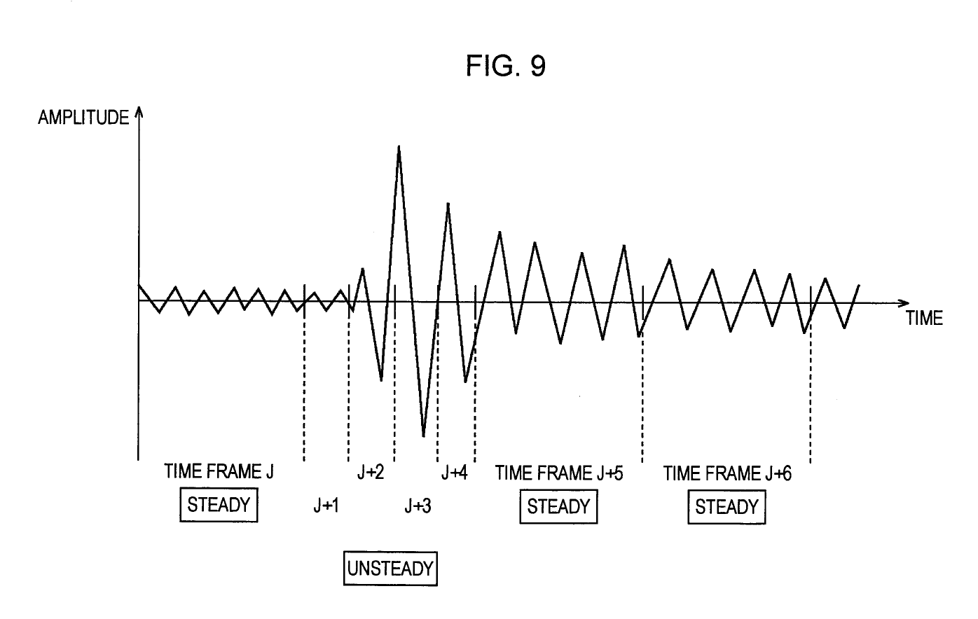

Here, a description will be given of steady/unsteady by way of the specific example in FIG. 8 and FIG. 9.

FIG. 8 is a diagram showing the waveform of a given time-series signal.

Of the four time frames from the time frame J to the time frame J+3, the time frame J, the time frame J+2, and the time frame J+3 are steady time frames. In contrast, the time frame J+1 is an unsteady time frame.

Generally, the attack portion of a percussion instrument, or the consonant portion of speech is said to have an unsteady signal waveform. To handle such steady/unsteady signal waveforms, in common audio encoding schemes such as MP3 and AAC previously mentioned, measures such as using short time frames in an unsteady time frame are taken.

FIG. 9 shows an example in which short time frames are applied to an unsteady time frame in this way.

According to the present invention, the time interval FSIZE can be changed adaptively by using such a technique based on steady/unsteady. Also, according to the present invention, the gain G_{db}(ib, J) can found by using different mapping functions separately for steady/unsteady cases. That is, it is possible to compute an optimum gain.

### Second Embodiment

Next, a second embodiment will be described.

In the second embodiment as well, as in the first embodiment, an input signal is reproduced with higher sound quality.

### Example of Functional Configuration of Frequency Band Extension Apparatus According to Second Embodiment

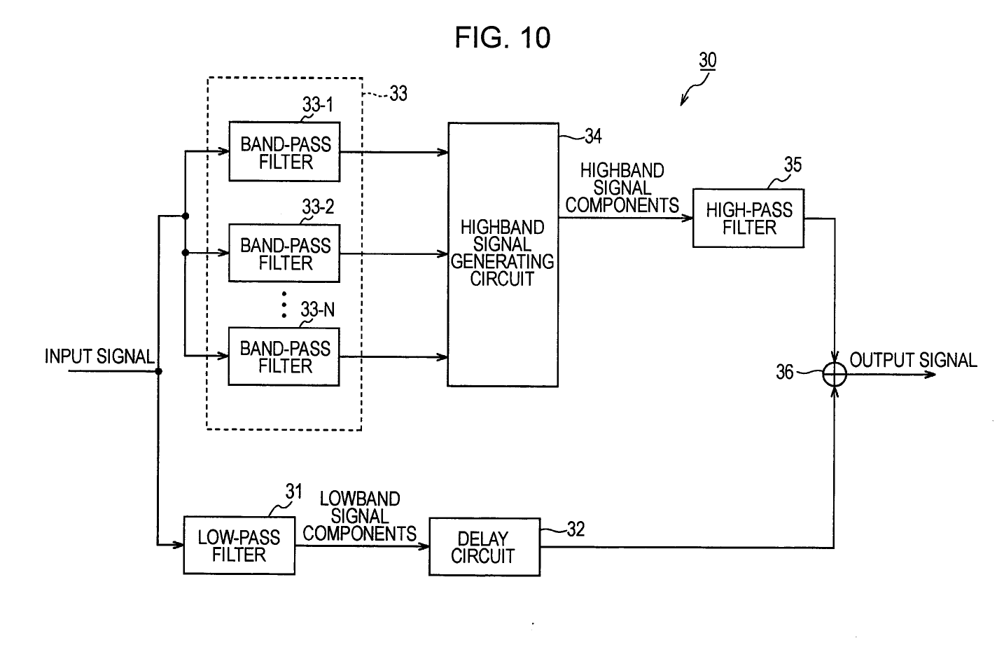

FIG. 10 shows an example of the functional configuration of a frequency band extension apparatus to which the present invention is applied.

A frequency band extension apparatus 30 applies, with decoded lowband signal components as an input signal, a frequency band extension process to the input signal, and outputs, as an output signal, the frequency-band-extended music signal obtained as a result.

The frequency band extension apparatus 30 includes a low-pass filter 31, a delay circuit 32, band-pass filters 33, a highband signal generating circuit 34, a high-pass filter 35, and a signal adder 36.

Here, of the frequency band extension apparatus 30 according to the second embodiment, the low-pass filter 31, the delay circuit 32, the band-pass filters 33, the high-pass filter 35, and the signal adder 36 have the same configurations and functions as the low-pass filter 11, the delay circuit 12, the band-pass filters 13, the high-pass filter 16, and the signal adder 17 according to the first embodiment, respectively.

Accordingly, here, description of these processing is omitted, and in the following, description will be given of only the processing in the highband signal generating circuit 34.

### Example of Processing in Highband Signal Generating Circuit 34

First, the highband signal generating circuit 34 finds power in a given predetermined time frame J, power (ib, J), with respect to eight subband signals x(ib, n) of sb−8 to sb−1 outputted from the band-pass filters 33, in accordance with Equation (1).

Next, the highband signal generating circuit 34 performs linear combination using the power power (ib, J) of each subband signal, and estimates estimated power, power (ib, J), of each subband signal in the frequency extension band by Equation (11) below.

$$\begin{matrix}[ Eq . 11 ] & \\ power ( ib , J ) = {\sum }_{kb = sb - 8}^{sb - 1} \{ {A}_{ib , 0 , 1} ( kb ) * power ( kb , J ) \} + {B}_{ib} \\ ( J * FSIZE <= n <= ( J + 1 ) * FSIZE - 1 , sb <= ib <= eb ) & ( 11 )\end{matrix}$$

In Equation (11), A_{ib,0,1}(kb) and B_{ib} are coefficients having different values for every subband ib. It is preferable that each of the coefficient A_{ib,0,1}(kb) and the coefficient B_{ib} be set appropriately so that preferable values can be obtained with respect to various input signals. Also, it is preferable to change each of the coefficients A_{ib,0,1}(kb) and B_{ib} to an optimal value with a change of sb.

The technique for computing the coefficient A_{ib,0,1}(kb) and the coefficient B_{ib} can be determined by performing learning by using a wide-band teacher signal as in the first embodiment.

It should be noted that the estimated power of each subband signal in the frequency extension band is computed by a first-order linear combination equation using the power of each of a plurality of subband signals outputted from the band-pass filters 33. However, the technique for computing the estimated power of each subband signal in the frequency extension band is not limited to this example. For example, as in the first embodiment, a technique using linear combination of frames preceding and following the time frame J may be adopted, or a technique using a non-linear function may be adopted.

Equation (12) is an equation for computing subband signal power in the frequency extension band by using linear combination of the subband signal powers in frames immediately preceding and following the time frame J.

$$\begin{matrix} [ Eq . 12 ] & \\ power ( ib , J ) = {\sum }_{kb = sb - 8}^{sb - 1} {\sum }_{ifrm = - 1}^{1} \{ {A}_{ib , ifrm , 1} ( kb ) * power ( kb , J + ifrm ) \} + {B}_{ib} \\ ( J * FSIZE <= n <= ( J + 1 ) * FSIZE - 1 , sb <= ib <= eb ) & ( 12 )\end{matrix}$$

By finding the power power (ib, J) in this way, a higher accuracy estimation can be performed by taking variations in subband signal power on the temporal axis into account. While this embodiment uses subband signal powers in immediately preceding and following frames, the number of these frames can be set while taking the amount of calculation into consideration, and the present invention is not to be limited by the number of preceding and following frames.

Equation (13) is an equation for computing the subband signal power in the frequency extension band by using a third-order function as an embodiment of a non-linear function.

$$\begin{matrix}[ Eq . 13 ] & \\ power ( ib , J ) = {\sum }_{kb = sb - 8}^{sb - 1} {\sum }_{ip = 1}^{3} \{ {A}_{ib , 0 , ip} ( kb ) * {power}^{ip} ( kb , J ) \} + {B}_{ib} \\ ( J * FSIZE <= n <= ( J + 1 ) * FSIZE - 1 , sb <= ib <= eb ) & ( 13 )\end{matrix}$$

By finding the power power (ib, J) in this way, the subband signal power in the frequency extension band can be estimated with higher accuracy. While this embodiment uses a non-linear function using a third-order equation, this order can be set while taking the amount of calculation into consideration, and it is desirable to take a large order in the case of a device with abundant calculation resources. Also, the present invention is applicable to a combination of Equation (12) and Equation (13), and the number of preceding and following frames and the order of the non-linear function can be set optimally in accordance with the calculation resources of a device. Also, in the present invention, various non-linear functions can be applied, without limitation to the order or kind of this non-linear function.

Next, in accordance with Equation (14) below, the highband signal generating circuit 34 finds the gain G(ib, J) by using the power power (sbₘₐₚ(ib), J) of each subband signal outputted from the band-pass filters 33, and the estimated power power(ib, J) of each subband signal in the frequency extension band found by Equation (11) (or Equation (12) or Equation (13)).

[Eq. 14]

G(ib,J)=sqrt [symbol] (power(ib,J)/power(sbₘₐₚ(ib),J) [symbol] (sb≦ib≦eb) (14)

The highband signal generating circuit 34 generates highband signal components by using the found gain G(ib, J). It should be noted that as the technique for generating highband signal components by using the gain G(ib, J), the same technique as in the first embodiment, that is, the same technique as the technique described by using Equation (4) to Equation (8) can be adopted.

It should be noted that in the second embodiment as well, as in the first embodiment, it is also possible to use not only continuous or curved line function approximation but also a codebook such that its input is the power of each of the plurality of subband signals obtained from the outputs of the band-pass filters 33 and its output is the gain G(ib, J).

In this way, the individual powers of a plurality of subband signals in the frequency extension band can be directly found from the powers of the plurality of subband signals outputted from the band-pass filters 33. Then, the strength and shape of the power spectrum in the frequency extension band can be varied in accordance with the property of an input signal. As a result, it is possible to generate a signal with high sound quality.

### Another Example of Estimation of Powers of Subband Signals in Frequency Extension Band

In the foregoing, the description is directed to the case of using a plurality of frames preceding and following the time frame J. In this case, in Equation (12), it is necessary to prepare a coefficient A having a number of elements equal to the number obtained by multiplying all of the number of subband signals in the frequency extension band, the number of subband signals used for estimation of the powers of subband signals in the frequency extension band, and the number of the preceding and following frames. The increase in the number of elements of the coefficient A leads to an increase in the amount of memory required for computation.

Incidentally, in Equation (12), the powers of subband signals in the frequency extension band are estimated by multiplying the power of each subband signal in each frame by each element of the coefficient A, and then adding them up.

That is, the size of the value of each element of the coefficient A indicates the degree of contribution of the power of each subband signal in each frame to the estimation of the powers of subband signals in the frequency extension band. Also, this degree of contribution can be considered as including both a component indicating the degree of contribution in the temporal direction (frame direction), and a component indicating the degree of contribution in the subband direction.

The coefficient A can be divided into a coefficient S indicating the degree of contribution in the temporal direction, and a coefficient R indicating the degree of contribution in the subband direction. Also, assuming the degree of contribution in the temporal direction to be common cross all subbands, the number of elements of the coefficient S can be reduced. As a result, it is possible to reduce the total number of elements of coefficients used for estimation.

For example, the highband signal generating circuit 34 can compute Equation (12) in the manner as in Equation (15) below, by making the coefficient S indicating the degree of coefficient in the temporal direction common across all subbands. Equation (15) is an equation for computing the subband signal power in the frequency extension band by using linear combination of the powers of subband signals in the frames immediately preceding and following the time frame J.

$$\begin{matrix} [ Eq . 15 ] & \\ power ( ib , J ) = {\sum }_{kb = sb - 8}^{sb - 1} {R}_{ib} ( kb ) \{ {S}_{- 1} * power ( kb , J - 1 ) + {S}_{0} * power ( kb , J ) + {S}_{+ 1} * power ( kb , J + 1 ) \} + {C}_{ib} \\ ( J * FSIZE <= n <= ( J + 1 ) * FSIZE - 1 , sb <= ib <= eb ) & ( 15 )\end{matrix}$$

In Equation (15), a coefficient R_{ib}(kb) is a coefficient indicating the degree of contribution in the subband direction of each of the powers of subband signals to be linearly combined. A coefficient S₋₁, a coefficient S₀, and coefficient S₊₁ are coefficients indicating the degrees of contribution in the temporal direction of the powers of subband signals to be linearly combined.

As indicated by Equation (15), the coefficient S₋₁, the coefficient S₀, and the coefficient S₊₁ indicating the degrees of contribution in the temporal direction are used commonly across all subbands.

In Equation (15), the coefficient R_{ib}(kb) and a coefficient C_{ib} are coefficients having different values for every subband specified by ib. It is preferable that the coefficients R_{ib}(kb), the coefficient S₋₁, the coefficient S₀, the coefficient S₊₁, and the coefficient C_{ib} be set appropriately so that preferable values can be obtained with respect to various input signals. Also, it is preferable to change the coefficients R_{ib}(kb), the coefficient S₋₁, the coefficient S₀, the coefficient S₊₁, and the coefficient C_{ib} be optimal values with a change of sb.

As in the first embodiment, these coefficients R_{ib}(kb), coefficient S₋₁, coefficient S₀, coefficient S₊₁, and the coefficient C_{ib} can be determined by performing learning by using a wide-band teacher signal.

For example, a regression analysis such as the least squares method is performed by using the powers P_{J-1}, P_{J}, and P_{J+1} in the immediately preceding and following frames of a given subband in the frame J as explanatory variables, and the power P′ⱼ of a given subband in the frame J as an explained variable, thereby computing each of the coefficient S₋₁, the coefficient S₀, and the coefficient S₊₁.

At this time, these coefficients S may be computed by using any subband (substantially the same value is obtained upon computing the coefficients S in any subband).

Next, with respect to each of subbands, a regression analysis such as the least squares method is performed by using, as an explanatory variable, the power {S₋₁*P_{J-1}+S₀*P_{J}+S₊₁*P_{J+1}} to which the coefficient S₋₁, the coefficient S₀, and the coefficient S+₁ are applied, and the power of each of subbands in the estimated band as an explained variable, thereby computing the coefficient R_{ib}(kb) and the coefficient C_{ib}.

In this way, assuming the degree of contribution in the temporal direction to be common across all subbands, and by using the coefficient indicating this degree of contribution in the temporal direction commonly across all subbands, the total number of elements of coefficients can be reduced. For example, while Equation (12) is an equation for estimating the subband signal power in the frequency extension band by using three subbands in three frames, in this case, the total number of elements of coefficients used for estimation is (eb-sb+1)*10. In contrast, with the method according to Equation (15), the total number of elements of coefficients used for estimation is (eb-sb+1)*2+3.

By reducing the total number of elements of coefficients required for estimation in this way, the amount of memory required for a computation for estimating highband power can be reduced.

Also, the temporal variation of the highband power estimated by the frequency band extension apparatus 30 tends to be large. This temporal variation of highband components may give the user a “jittering” auditory sensation.

As indicated by Equation (15), substituting the powers in a plurality of time frames by a single variable for every subband is equivalent to performing smoothing in the temporal direction of power for every subband. Therefore, by performing such computation, the time variation of power as a variable used for estimation is suppressed, and the time variation of a value estimated is thus suppressed. Thus, the “jittering sensation” given to the user can be mitigated.

It should be noted that the difference between the residual mean square values of estimated power does not substantially vary between when estimation is performed using Equation (15) and when estimation is performed using Equation (12). That is, substantially the same estimation accuracy can be obtained (estimation accuracy does not vary substantially) even if the coefficient indicating the degree of contribution in the temporal direction of each subband is made common.

### Third Embodiment

Next, a third embodiment will be described.

The third embodiment is an embodiment in which the present invention is applied to encoding and decoding of a signal to perform high-efficiency encoding.

### Example of Functional Configuration of Encoding Apparatus According to Third Embodiment

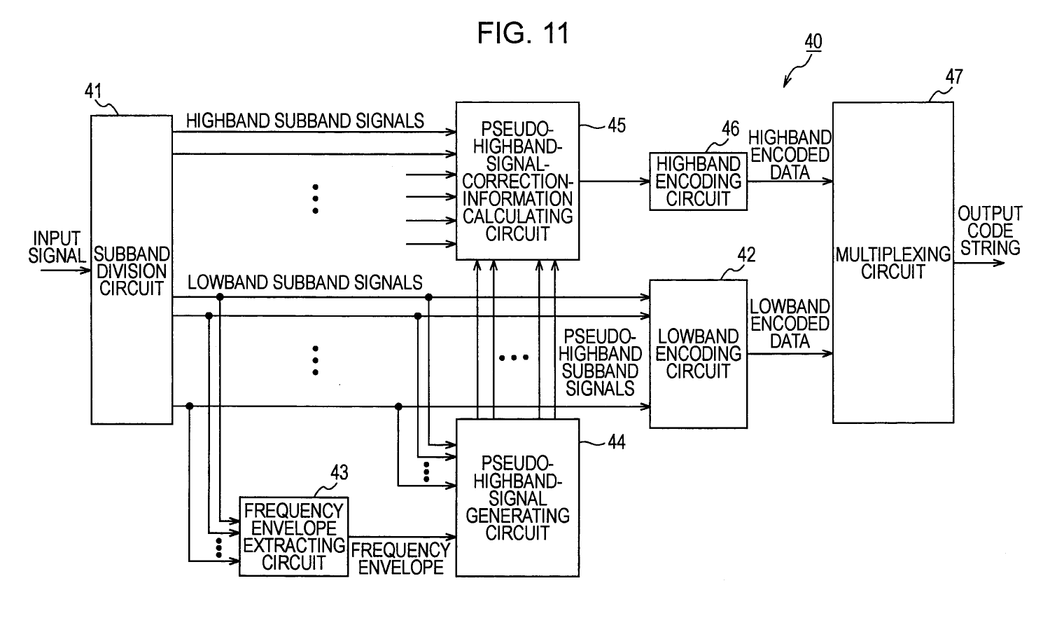

FIG. 11 shows an example of the functional configuration of an encoding apparatus to which the present invention is applied.

An encoding apparatus 40 includes a subband division circuit 41, a lowband encoding circuit 42, a frequency envelope extracting circuit 43, a pseudo-highband-signal generating circuit 44, a pseudo-highband-signal-correction-information calculating circuit 45, a highband encoding circuit 46, and a multiplexing circuit 47.

### Example of Processing in Encoding Apparatus according to Third Embodiment

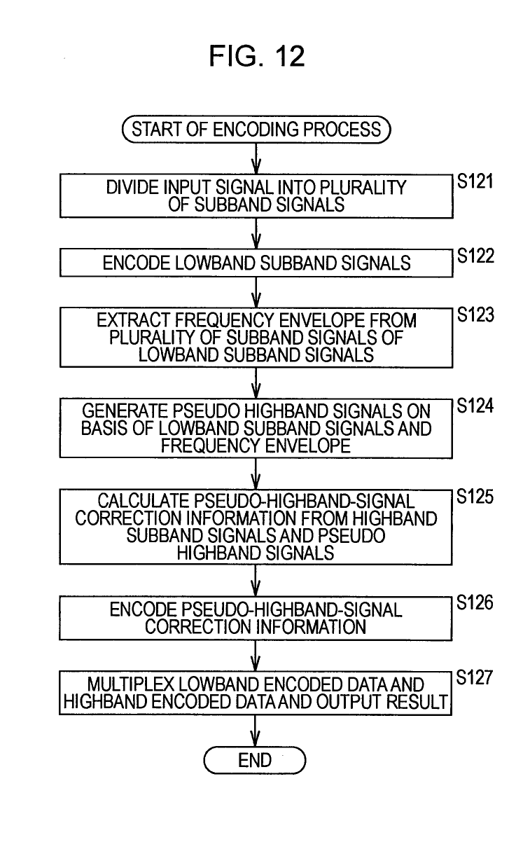

FIG. 12 is a flowchart illustrating an example of processing in the encoding apparatus in FIG. 11 (hereinafter, referred to as encoding process).

In step S121, the subband division circuit 41 equally divides an input signal into a plurality of subband signals having a predetermined bandwidth. Of these plurality of subband signals, subband signals in the band lower than a given frequency (hereinafter, referred to as lowband subband signals) are supplied to the lowband encoding circuit 42, the frequency envelope extracting circuit 43, and the pseudo-highband-signal generating circuit 44. In contrast, subband signals in the band higher than the given frequency (hereinafter, referred to as highband subband signals) are supplied to the pseudo-highband-signal-correction-information calculating circuit 45.

In step S122, the lowband encoding circuit 42 encodes the lowband subband signals outputted from the subband division circuit 41, and supplies lowband encoded data obtained as a result to the multiplexing circuit 47.

With regard to this encoding of lowband subband signals, an appropriate encoding scheme may be selected in accordance with the encoding efficiency or required circuit scale, and the present invention is not dependent on this encoding scheme.

In step S123, the frequency envelope extracting circuit 43 extracts a frequency envelope from a plurality of subband signals of the lowband subband signals outputted from the subband division circuit 41, and supplies the frequency envelope to the pseudo-highband-signal generating circuit 44. It should be noted that the frequency envelope extracting circuit 43 has basically the same configuration and function as the frequency envelope extracting circuit 14 in the first embodiment. Hence, description of its processing or the like is omitted here.

In step S124, the pseudo-highband-signal generating circuit 44 generates pseudo highband signals, on the basis of the plurality of subband signals of the lowband subband signals outputted from the subband division circuit 41, and the frequency envelope outputted from the frequency envelope extracting circuit 43, and supplies the pseudo highband signals to the pseudo-highband-signal-correction-information calculating circuit 45. The pseudo-highband-signal generating circuit 44 may operate in basically the same manner as the highband signal generating circuit 15 in the first embodiment. The only difference is that there is no need for the cosine modulation process for changing the frequencies of subband signals. Hence, description of the process or the like is omitted here.

In step S125, the pseudo-highband-signal-correction-information calculating circuit 45 calculates pseudo-highband-signal correction information, on the basis of the highband subband signals outputted from the subband division circuit 41, and the pseudo highband signals outputted from the pseudo-highband-signal generating circuit 44, and supplies the pseudo-highband-signal correction information to the highband encoding circuit 46.

Here, description will be given of an example of processing in the pseudo-highband-signal-correction-information calculating circuit 45.

First, the pseudo-highband-signal-correction-information calculating circuit 45 calculates power power (ib, J) in a given predetermined time frame J, with respect to the highband subband signals outputted from the subband division circuit 41. It should be noted that in this embodiment, all of the subbands of lowband subband signals and subbands of highband subband signals are identified by using ib. As for the technique for calculating power, the same technique as the calculation technique in the first embodiment, that is, the technique using Equation (1) can be adopted.

Next, the pseudo-highband-signal-correction-information calculating circuit 45 finds the difference power_{diff}(ib, J) between the power power (ib, J) of each highband subband signal, and the power in a given predetermined time frame of each pseudo highband signal outputted from the pseudo-highband-signal generating circuit 44. The difference power_{diff}(ib, J) can be found by Equation (16) below.

[Eq. 16]

power_{diff}(ib,J)=power(ib,J)−powerₗₕ(ib,J)(sb≦ib≦eb) (16)

In Equation (16), powerₗₕ(ib, J) denotes power in the time frame J with respect to, among subband signals constituting the pseudo highband signals outputted from the pseudo-highband-signal generating circuit 44 (hereinafter, referred to as pseudo-highband subband signals), a pseudo-highband subband signal with respect to a subband ib. In this embodiment, sb indicates the lowest subband in the highband subband signals. eb indicates the highest subband in the highband subband signals to be encoded.

Next, the pseudo-highband-signal-correction-information calculating circuit 45 determines whether or not the absolute value of the difference power_{diff}(ib, J) in each subband id is equal to or less than a given threshold A.

If it is determined that the absolute value of power_{diff}(ib, J) is equal to or less than the threshold A in all of subbands, the pseudo-highband-signal-correction-information calculating circuit 45 sets a pseudo-highband-signal correction flag to 00. Then, the pseudo-highband-signal-correction-information calculating circuit 45 supplies only this pseudo-highband-signal correction flag to the highband encoding circuit 46 as pseudo-highband-signal correction information.

In contrast, if it is determined that the absolute value of power_{diff}(ib, J) in a given subband ib exceeds the threshold A, the pseudo-highband-signal-correction-information calculating circuit 45 sets the pseudo-highband-signal correction flag to 01. The pseudo-highband-signal-correction-information calculating circuit 45 supplies the power_{diff}(ib, J) in the subband ib itself as pseudo-highband-signal correction data, to the highband encoding circuit 46 together with the pseudo-highband-signal correction flag.

Also, if it is determined that the absolute value of power_{diff}(ib, J) in a given subband ib is equal to or larger than a given threshold B that is even larger than the threshold A, the pseudo-highband-signal-correction-information calculating circuit 45 sets the pseudo-highband-signal correction flag to 10. The pseudo-highband-signal-correction-information calculating circuit 45 supplies the power_{diff}(ib, J) in the subband ib itself as highband signal data, to the highband encoding circuit 46 together with the pseudo-highband-signal correction flag.

In step S126, the highband encoding circuit 46 encodes the pseudo-highband-signal correction information. Thus, since each highband subband signal is encoded into a pseudo-highband-signal correction flag, pseudo-highband-signal correction data, or highband signal data with a small data size, efficient encoding can be performed. The highband encoding circuit 46 supplies highband encoded data obtained by the encoding to the multiplexing circuit 47.

It should be noted that as the encoding scheme in the highband encoding circuit 46, like the encoding scheme for lowband subband signals, a well-known common encoding scheme can be adopted in accordance with the encoding efficiency or circuit scale.

In step S127, the multiplexing circuit 47 multiplexes lowband encoded data outputted from the lowband encoding circuit 42, and the highband encoded data outputted from the highband encoding circuit 46, and outputs an output code string.

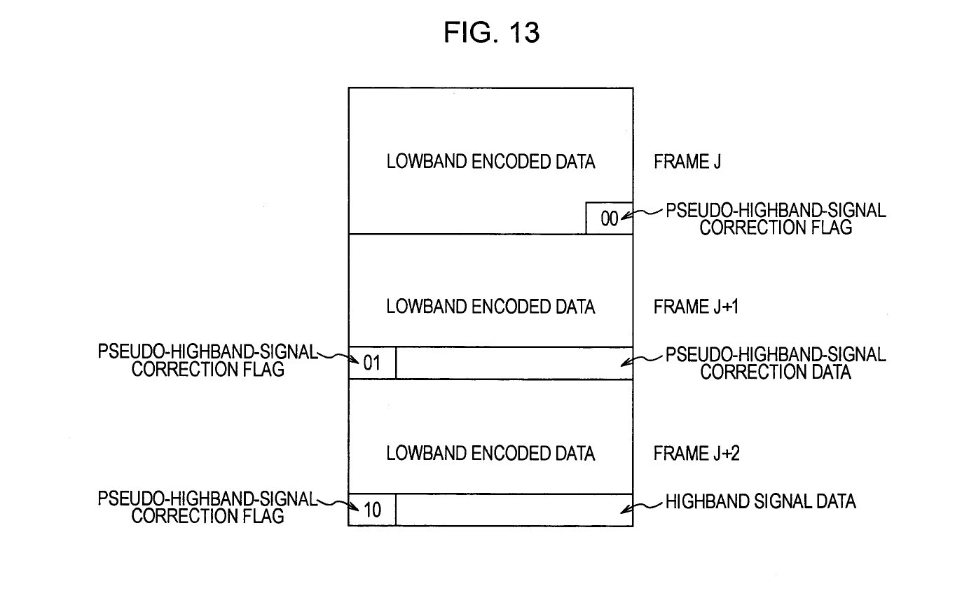

FIG. 13 shows an example of an output code string.

Since only the pseudo-highband-signal correction flag 00 is encoded, and the pseudo-highband-signal correction data is not encoded in the time frame J, more bits can be allocated to encoding of lowband subband signals.

Also, in the case of a time frame J+2 in which the highband signals and the pseudo highband signals differ greatly, it is possible to prevent sound quality degradation by recording power(ib, J) itself as highband signal data.

### Example of Functional Configuration of Decoding Apparatus According to Third Embodiment

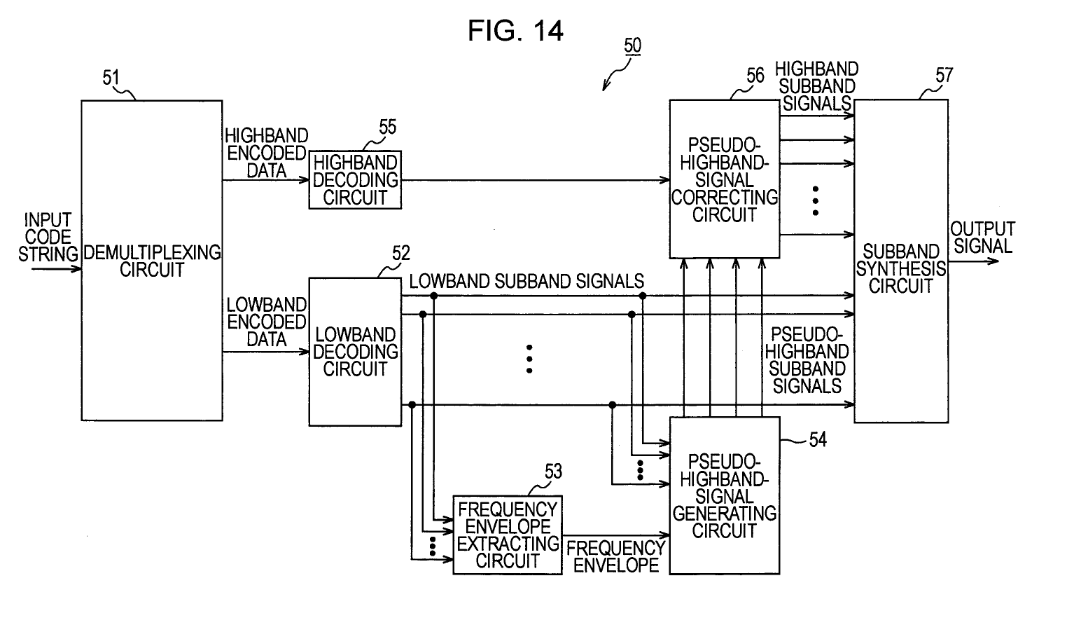

FIG. 14 shows an example of the functional configuration of a decoding apparatus corresponding to the encoding apparatus according to the third embodiment in FIG. 11. That is, an example of the configuration of a decoding apparatus 50 to which the present invention is applied is shown in FIG. 14.

The decoding apparatus 50 includes a demultiplexing circuit 51, a lowband decoding circuit 52, a frequency envelope extracting circuit 53, a pseudo-highband-signal generating circuit 54, a highband decoding circuit 55, a pseudo-highband-signal correcting circuit 56, and a subband synthesis circuit 57.

### Example of Processing in Decoding Apparatus according to Third Embodiment

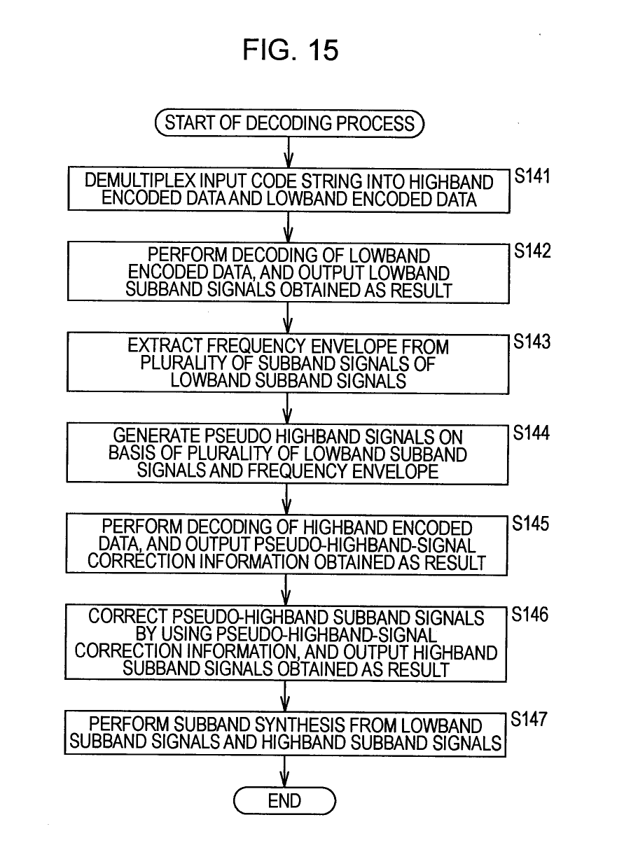

FIG. 15 is a flowchart illustrating an example of processing in the decoding apparatus in FIG. 14 (hereinafter, referred to as decoding process).

In step S141, the demultiplexing circuit 51 demultiplexes an input code string into highband encoded data and lowband encoded data. The lowband encoded data is supplied to the lowband decoding circuit 52, and the highband encoded data is supplied to the highband decoding circuit 55.

In step S142, the lowband decoding circuit 52 decodes the lowband encoded data outputted from the demultiplexing circuit 51. Lowband subband signals obtained as a result are supplied to the frequency envelope extracting circuit 53, the pseudo-highband-signal generating circuit 54, and the subband synthesis circuit 57.

In step S143, the frequency envelope extracting circuit 53 extracts a frequency envelope from a plurality of subband signals of the lowband subband signals outputted from the lowband decoding circuit 52, and supplies the frequency envelope to the pseudo-highband-signal generating circuit 54. The frequency envelope extracting circuit 53 has basically the same configuration and function as the frequency envelope extracting circuit 43 of the encoding apparatus 40. Hence, description of its processing or the like is omitted here.

In step S144, the pseudo-highband-signal generating circuit 54 generates pseudo highband signals, on the basis of a plurality of subband signals of the lowband subband signals outputted from the lowband decoding circuit 52, and the frequency envelope outputted from the frequency envelope extracting circuit 53. The pseudo highband signals are supplied to the pseudo-highband-signal correcting circuit 56. The pseudo-highband-signal generating circuit 54 has basically the same configuration and function as the pseudo-highband-signal generating circuit 44 of the encoding apparatus 40. Hence, description of its processing or the like is omitted here.

In step S145, the highband decoding circuit 55 decodes the highband encoded data outputted from the demultiplexing circuit 51, and supplies pseudo-highband-signal correction information obtained as a result to the pseudo-highband-signal correcting circuit 56.

In step S146, the pseudo-highband-signal correcting circuit 56 corrects the pseudo highband signals outputted from the pseudo-highband-signal generating circuit 54, by using the pseudo-highband-signal correction information outputted from the highband decoding circuit 55. As a result, highband subband signals are obtained, and supplied to the subband synthesis circuit 57.

Here, if the pseudo-highband-signal correction flag in the pseudo-highband-signal correction information is 00, pseudo highband signals are outputted as highband subband signals. If the pseudo-highband-signal correction flag is 01, correction of the pseudo highband signals is performed by using the pseudo-highband-signal correction data, and if the pseudo-highband-signal correction flag is 10, correction of the pseudo highband signals is performed by using the highband signal data, and highband subband signals obtained as a result are outputted.

In step S147, the subband synthesis circuit 57 performs subband synthesis, from the lowband subband signals outputted by the lowband decoding circuit 52, and the highband subband signals outputted by the pseudo-highband-signal correcting circuit 56. The signal obtained as a result is outputted as an output signal.

In this way, with respect to highband signal components, normally, by using pseudo highband signals from the lowband, encoding can be performed so that their correction thereof is performed only when necessary with a small amount of bits. As a result, it is possible to perform high-efficiency encoding for various sound sources, even at low bit rates.

Further, with respect to signal encoding and decoding, the coefficient data in functions such as Equation (3) and Equation (11) carried out in the pseudo-highband-signal generating circuits 44 and 54 of the encoding apparatus 40 and the decoding apparatus 50 can be handled as follows. That is, it is also possible to use different coefficient data in accordance with the kind of input signal, and record the coefficients at the beginning of a code string in advance.

For example, by changing coefficient data depending on the signal such as speech or jazz, an improvement in encoding efficiency can be achieved.

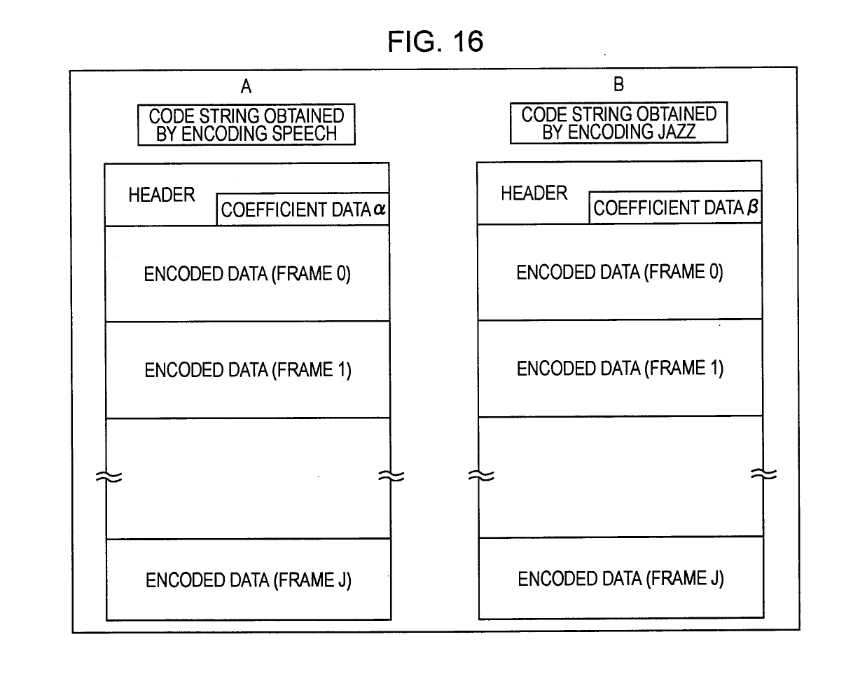

FIG. 16 is a diagram showing a code string obtained in this way.

The code string A in FIG. 16 is obtained by encoding speech, and optimal coefficient data a for speech is recorded in the header.

In contrast, the code string B in FIG. 16 is obtained by encoding jazz, and optimal coefficient data β for jazz is recorded in the header.

Such plurality of pieces of coefficient data may be prepared by learning with the same kind of music signal in advance, and the encoding apparatus 40 may select the coefficient data on the basis of genre information such as one recorded in the header of an input signal. Alternatively, coefficient data may be selected by determining the genre by performing a signal waveform analysis. That is, such a signal genre analysis technique is not particularly limited.

Also, if the calculation time permits, it is also possible to have the above-mentioned learning apparatus built in the encoding apparatus 40, perform processing using coefficients specific to its signal, and lastly record the coefficients in the header.

Also, it is also possible to adopt such a mode in which such coefficient data is inserted once every several frames.

While the pseudo-highband-signal generating circuit 44 and the pseudo-highband-signal generating circuit 54 in the third embodiment described in the foregoing may each operate in basically the same manner as the highband signal generating circuit 15 in the first embodiment, in the present invention, it is also possible to perform the operation of this pseudo-highband-signal generating circuit by using the highband signal generating circuit 34 in the second embodiment. Also, a method is also possible in which the pseudo-highband-signal correction information is provided with a selection flag for the pseudo-highband-signal generating method, and whether the method according to the first embodiment or the method according to the second embodiment is to be performed as the pseudo-highband-signal generating method is selected in accordance with the value of the flag.

The series of processes described above can be either executed by hardware or executed by software. If the series of processes is to be executed by software, a program constituting the software is installed into a computer embedded in dedicated hardware, or into, for example, a general purpose personal computer or the like that can execute various functions when installed with various programs, from a program-recording medium.

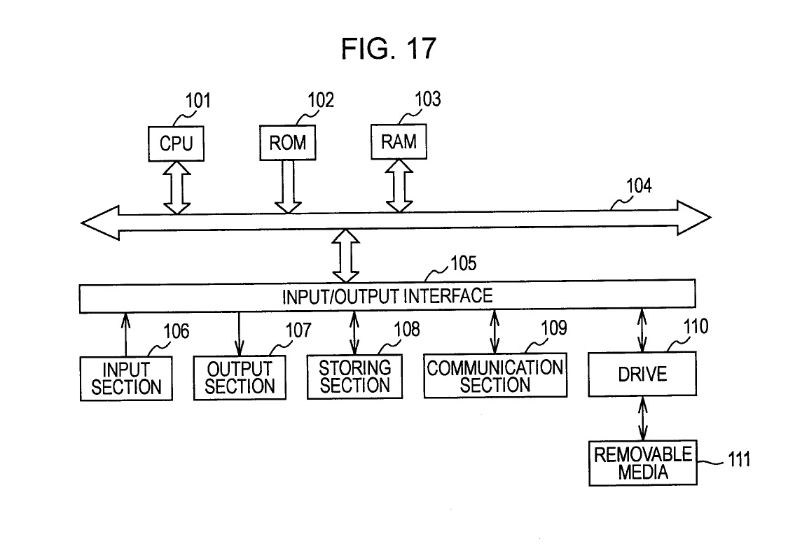

FIG. 17 is a block diagram showing an example of the hardware configuration of a computer that executes the series of processes mentioned above by a program.

In the computer, a CPU 101, a ROM (Read Only Memory) 102, and a RAM (Random Access Memory) 103 are connected to each other via a bus 104.

The bus 104 is further connected with an input/output interface 105. The input/output interface 105 is connected with an input section 106 made of a keyboard, a mouse, a microphone, or the like, an output section 107 made of a display, a speaker, or the like, a storing section 108 made of a hard disk, a non-volatile memory, or the like, a communication section 109 made of a network interface or the like, and a drive 110 for driving removable media 111 such as a magnetic disc, an optical disc, a magneto-optical disc, or a semiconductor memory.

In the computer configured as described above, the above-mentioned series of processes is performed by the CPU 101 loading a program stored in the storing section 108 into the RAM 103 via the input/output interface 105 and the bus 104, and executing the program, for example.

The program executed by the computer (CPU 101) is provided by being recorded on the removable media 111 that is package media made of, for example, a magnetic disc (including a flexible disc), an optical disc (such as a CD-ROM (Compact Disc-Read Only Memory) or a DVD (Digital Versatile Disc)), a magneto-optical disc, or a semiconductor memory or the like, or via a wired or wireless transmission medium such as a local area network, Internet, or digital satellite broadcast.

Then, the program can be installed into the storing section 108 via the input/output interface 105, by mounting the removable media 111 in the drive 110. Also, the program can be received by the communication section 109 via a wired or wireless transmission medium, and installed into the storing section 108. Alternatively, the program can be pre-installed into the ROM 102 or the storing section 108.

It should be noted that the program executed by the computer may be a program in which processes are performed in time-series in the order as described in this specification, or may be a program in which processes are performed at necessary timing such as when invoked.

Also, embodiments of the present invention are not limited to the above-described embodiments, and various modifications are possible without departing from the scope of the present invention.

### REFERENCE SIGNS LIST

10 frequency band extension apparatus, 11 low-pass filter, 12 delay circuit, 13 band-pass filters, 14 frequency envelope extracting circuit, 15 highband signal generating circuit, 16 high-pass filter, 17 signal adder, 20 frequency band extension apparatus, 21 band-pass filters, 22 gain calculating circuit, 23 frequency envelope extracting circuit, 24 coefficient estimating circuit, 30 frequency band extension apparatus, 31 low-pass filter, 32 delay circuit, 33 band-pass filters, 34 highband signal generating circuit, 35 high-pass filter, 36 signal adder, 40 encoding apparatus, 41 subband division circuit, 42 lowband encoding circuit, 43 frequency envelope extracting circuit, 44 pseudo-highband-signal generating circuit, 45 pseudo-highband-signal-correction-information calculating circuit, 46 highband encoding circuit, 47 multiplexing circuit, 50 decoding apparatus, 51 demultiplexing circuit, 52 lowband decoding circuit, 53 frequency envelope extracting circuit, 54 pseudo-highband-signal generating circuit, 55 highband decoding circuit, 56 pseudo-highband-signal correcting circuit, 57 subband synthesis circuit, 101 CPU, 102 ROM, 103 RAM, 104 bus, 105 input/output interface, 106 input section, 107 output section, 108 storing section, 109 communication section, 110 drive, 111 removable media

1. A frequency band extension apparatus, comprising:
a plurality of band-pass filters that obtain a plurality of subband signals from an input signal;
a frequency envelope extracting circuit that extracts a frequency envelope from the plurality of subband signals obtained by the plurality of band-pass filters; and
a highband signal generating circuit that generates highband signal components, on the basis of the frequency envelope obtained by the frequency envelope extracting circuit, and the plurality of subband signals obtained by the band-pass filters,
wherein a frequency band of the input signal is extended by using the highband signal components generated by the highband signal generating circuit.

2. The frequency band extension apparatus according to claim 1, wherein the frequency envelope extracting circuit obtains a first-order slope of the frequency envelope from the plurality of subband signals obtained by the plurality of band-pass filters.

3. The frequency band extension apparatus according to claim 1 or claim 2, wherein, in the frequency envelope extracting circuit, when extracting the frequency envelope from the plurality of subband signals obtained by the plurality of band-pass filters, powers of the plurality of subband signals are used.

4. The frequency band extension apparatus according to claim 1 or claim 2, wherein, in the frequency envelope extracting circuit, when extracting the frequency envelope from the plurality of subband signals obtained by the plurality of band-pass filters, amplitudes of the plurality of subband signals are used.

5. The frequency band extension apparatus according to claim 2, wherein in the frequency envelope, a calculation segment for the frequency envelope varies depending on steadiness of the input signal.

6. The frequency band extension apparatus according to claim 1, wherein the frequency envelope extracting circuit obtains a plurality of first-order slopes of the frequency envelope from the plurality of subband signals obtained by the plurality of band-pass filters.

7. The frequency band extension apparatus according to claim 1, wherein the highband signal generating circuit includes a gain calculating circuit that finds a gain for each subband from the frequency envelope obtained by the frequency envelope extracting circuit, and applies the gain to the plurality of subband signals obtained by the plurality of band-pass filters.

8. The frequency band extension apparatus according to claim 7, wherein the gain calculating circuit finds the gain for each subband from the frequency envelope calculated in each of a plurality of blocks on a temporal axis.

9. The frequency band extension apparatus according to claim 2, wherein the first-order slope of the frequency envelope is computed in a weighted manner from the plurality of subband signals obtained by the plurality of band-pass filters.

10. The frequency band extension apparatus according to claim 7, wherein in the gain calculating circuit, the gain is computed by a mapping function obtained by performing learning in advance with a wide-band signal as teacher data.

11. The frequency band extension apparatus according to claim 10, wherein the mapping function has a first-order slope as input and the gain as output.

12. The frequency band extension apparatus according to claim 10, wherein the mapping function has each of a plurality of first-order slopes as input and the gain as output.

13. The frequency band extension apparatus according to claim 10, wherein the mapping function has a first-order slope on a logarithmic scale as input and the gain on a logarithmic scale as output.

14. The frequency band extension apparatus according to claim 2, further comprising a highband-subband-strength generating circuit that generates strengths of individual highband subbands in a frequency extension band from the plurality of subband signals obtained by the plurality of band-pass filters.

15. The frequency band extension apparatus according to claim 14, wherein the highband-subband-strength generating circuit computes the strengths of the individual highband subbands in the frequency extension band from linear combination of strengths of the plurality of subband signals obtained by the plurality of band-pass filters.

16. The frequency band extension apparatus according to claim 14, wherein the highband-subband-strength generating circuit computes the strengths of the individual highband subbands in the frequency extension band from linear combination of a plurality of subband signal strengths calculated in a plurality of blocks on a temporal axis.

17. The frequency band extension apparatus according to claim 16, wherein the highband-subband-strength generating circuit computes the strengths of the individual highband subbands in the frequency extension band, by using the plurality of subband signal strengths calculated in the plurality of blocks on the temporal axis which are substituted by a single variable for each subband.

18. The frequency band extension apparatus according to claim 14, wherein the highband-subband-strength generating circuit computes the strengths of the individual highband subbands in the frequency extension band by using a non-linear function from strengths of the plurality of subband signals obtained by the plurality of band-pass filters.

19. The frequency band extension apparatus according to claim 14, wherein the highband-subband-strength generating circuit computes the strengths of the individual highband subbands in the frequency extension band by using a non-linear function from a plurality of subband signal strengths calculated in a plurality of blocks on a temporal axis.

20. The frequency band extension apparatus according to claim 18 or 19, wherein the non-linear function is a function of an arbitrary order.

21. The frequency band extension apparatus according to any one of claims 14 to 16, wherein input and output of the highband-subband-strength generating circuit are powers of the plurality of subband signals obtained by the plurality of band-pass filters, and powers of the highband subbands, respectively.

22. The frequency band extension apparatus according to any one of claims 14 to 16, wherein input and output of the highband-subband-strength generating circuit are amplitudes of the plurality of subband signals obtained by the plurality of band-pass filters, and amplitudes of the highband subbands, respectively.

23. The frequency band extension apparatus according to claim 15, wherein in the gain calculating circuit, the gain is computed by a mapping function having coefficients obtained by performing learning in advance with a wide-band signal as teacher data.

24. A frequency band extension method comprising a frequency band extending apparatus:
obtaining a plurality of subband signals from an input signal;
extracting a frequency envelope from the obtained plurality of subband signals;
generating highband signal components on the basis of the extracted frequency envelope, and the obtained plurality of subband signals; and
extending a frequency band of the input signal by using the generated highband signal components.

25. A program for causing a computer controlling a frequency band extension apparatus to execute a control process including the steps of:
obtaining a plurality of subband signals from an input signal;
extracting a frequency envelope from the obtained plurality of subband signals;
generating highband signal components on the basis of the extracted frequency envelope, and the obtained plurality of subband signals; and
extending a frequency band of the input signal by using the generated highband signal components.

26. An encoding apparatus comprising:
a subband division circuit that divides an input signal into a plurality of subbands, and generates lowband subband signals including a plurality of subbands on a lowband side, and highband subband signals including a plurality of subbands on a highband side;
a lowband encoding circuit that encodes the lowband subband signals, and generates lowband encoded data;
a frequency envelope extracting circuit that extracts a frequency envelope from the lowband subband signals;
a pseudo-highband-signal generating circuit that generates pseudo highband signals, from the frequency envelope obtained by the frequency envelope extracting circuit and the lowband subband signals;
a pseudo-highband-signal-correction-information calculating circuit that compares the highband subband signals obtained by the subband division circuit with the pseudo highband signals generated by the pseudo-highband-signal generating circuit, and obtains pseudo-highband-signal correction information;
a highband encoding circuit that encodes the pseudo-highband-signal correction information, and generates highband encoded data; and
a multiplexing circuit that multiplexes the lowband encoded data generated by the lowband encoding circuit and the highband encoded data generated by the highband encoding circuit to obtain an output code string.

27. An encoding method comprising the steps of an encoding apparatus:
dividing an input signal into a plurality of subbands, and generating lowband subband signals including a plurality of subbands on a lowband side, and highband subband signals including a plurality of subbands on a highband side;
encoding the lowband subband signals, and generating lowband encoded data;
extracting a frequency envelope from the lowband subband signals;
generating pseudo highband signals from the extracted frequency envelope and the lowband subband signals;
comparing the highband subband signals with the generated pseudo highband signals, and obtaining pseudo-highband-signal correction information;
encoding the pseudo-highband-signal correction information, and generating highband encoded data; and
multiplexing the generated lowband encoded data and the generated highband encoded data to obtain an output code string.

28. A program for causing a computer controlling an encoding apparatus to execute a control process including the steps of:
dividing an input signal into a plurality of subbands, and generating lowband subband signals including a plurality of subbands on a lowband side, and highband subband signals including a plurality of subbands on a highband side;
encoding the lowband subband signals, and generating lowband encoded data;
extracting a frequency envelope from the lowband subband signals;
generating pseudo highband signals from the extracted frequency envelope and the lowband subband signals;
comparing the highband subband signals with the generated pseudo highband signals, and obtaining pseudo-highband-signal correction information;
encoding the pseudo-highband-signal correction information, and generating highband encoded data; and
multiplexing the generated lowband encoded data and the generated highband encoded data to obtain an output code string.

29. A decoding apparatus comprising:
a demultiplexing circuit that demultiplexes inputted encoded data, and generates lowband encoded data and highband encoded data;
a lowband decoding circuit that decodes the lowband encoded data, and generates lowband subband signals;
a frequency envelope extracting circuit that extracts a frequency envelope from a plurality of subband signals of the lowband subband signals;
a pseudo-highband-signal generating circuit that generates pseudo highband signals, from the frequency envelope obtained by the frequency envelope extracting circuit and the lowband subband signals;
a highband decoding circuit that decodes the highband encoded data, and generates pseudo-highband-signal correction information; and
a pseudo-highband-signal correcting circuit that corrects the pseudo highband signals by using the pseudo-highband-signal correction information to generate corrected pseudo highband signals.

30. A decoding method comprising the steps of a decoding apparatus:
demultiplexing inputted encoded data, and generating lowband encoded data and highband encoded data;
decoding the lowband encoded data, and generating lowband subband signals;
extracting a frequency envelope from a plurality of subband signals of the lowband subband signals;
generating pseudo highband signals from the extracted frequency envelope and the lowband subband signals;
decoding the highband encoded data, and generating pseudo-highband-signal correction information; and
correcting the pseudo highband signals by using the pseudo-highband-signal correction information to generate corrected pseudo highband signals.

31. A program for causing a computer controlling a decoding apparatus to execute a control process including the steps of:
demultiplexing inputted encoded data, and generating lowband encoded data and highband encoded data;
decoding the lowband encoded data, and generating lowband subband signals;
extracting a frequency envelope from a plurality of subband signals of the lowband subband signals;
generating pseudo highband signals from the extracted frequency envelope and the lowband subband signals;
decoding the highband encoded data, and generating pseudo-highband-signal correction information; and
correcting the pseudo highband signals by using the pseudo-highband-signal correction information to generate corrected pseudo highband signals.
